(19) United States
(12) Patent Application Publication
(10) Pub. No.: US 2014/0361130 A1
(43) Pub. Date: Dec. 11, 2014

(54) Protective stand and carrying case for mobile devices

(71) Applicant: James Randolph Fenton, Redondo Beach, CA (US)

(72) Inventor: James Randolph Fenton, Redondo Beach, CA (US)

(21) Appl. No.: 13/986,825

(22) Filed: Jun. 8, 2013

(51) Int. Cl. F16M 11/04

(52) U.S. Cl. CPC F16M 11/04
USPC 248/176.1; 248/127

(57) ABSTRACT

A device stand for supporting and protecting mobile devices is described. The stand includes holders that secure the mobile device to the stand and bumpers that provide protection to the mobile device. The mobile device may be secured to and removed from the device stand.

### FIELD OF THE INVENTION

The field of the invention relates generally to devices for supporting, carrying and protecting electronic devices. More specifically, the invention relates to stands and carrying cases used for supporting, carrying and protecting mobile devices.

### BACKGROUND OF THE INVENTION

Because tablet computers (such as the iPad) and eReaders (such as the Kindle and the Nook) are made of hard plastic, metal and glass, and because these devices are flat and do not typically have handles, they are awkward to hold for long periods of time while reading or watching videos.

Also, the face of these devices are typically made of glass, as they may be touch screens, and can be easily damage if dropped onto a hard surface. Children are becoming a major demographic for using tablet computers and eReaders and therefore pose a danger for such devices because of their tendency to drop them.

In addition, stands for these devices that are currently on the market are typically made of hard plastic or metal and are not well suited for resting with a person comfortably positioned on a bed or a couch.

Also, protective corner bumpers that are currently available on the market do not incorporate a stand that is well suited for resting with a person comfortably positioned on a bed or couch.

In addition, there are a multitude of different mobile devices on the market of varying sizes, and typically, accessories made for one sized mobile device will not properly fit and therefore not work properly for mobile devices of other sizes and shapes.

As well, mobile devices are not only for home use and are often carried outside the home for use during a normal day. As mentioned above, many children are now using mobile devices, and they may wish to take their mobile device with them outside the house to school, to a friend's house and to other places. Once they arrive to their destination and wish to use the mobile device, they may wish to have it supported by a comfortable stand and be protected.

There is therefore a need for a holder for tablet computers and eReaders that is soft and comfortable to use while resting in bed or on the couch, and that also incorporates protective elements in order to protect the devices from damage resulting from taking a blow or from being dropped onto hard surfaces.

There is also a need for a holder of mobile devices to be adjustable such that it can be adjusted to fit and work with different mobile devices of different sizes and shapes.

There is also a need for a holder that may be used to safely transport mobile devices in a protective case and that may also transform into a comfortable stand for use while resting on in bed or on a couch.

### SUMMARY OF THE INVENTION

The present invention addresses the foregoing and other shortcomings of existing device stands.

One aspect of the present invention regards a device stand that may be wedge shaped, pyramid shaped, a hybrid combination of wedge shaped and pyramid shaped or other shapes. The device stand may include a face upon which a mobile device may be attached for safe and comfortable use.

Another aspect of the invention regards a rectangular block section that may extend from one side of the device stand upon which the mobile device may be attached. The rectangular block section may cause the device stand to be more stable with the mobile device attached.

In another aspect of the current invention, the device stand may include a handle.

In another aspect of the current invention, the device stand may include a pocket.

Another aspect of the current invention regards a sheet of Velcro that may be attached to at least one face of the device stand. This sheet of Velcro may facilitate the attaching of other components that may also have Velcro on their surface to the device stand.

In another aspect of the invention, gripping members may have Velcro on their surface and may be attached to the sheet of Velcro on at least one face of the device stand to grip a mobile device such as a smartphone, a tablet computer, a personal digital assistant, a portable media player or other mobile device. The position of the gripping members on the face of the device stand may be adjustable because they may be attached to the Velcro sheet and the Velcro sheet may cover a wide area on the face of the stand. This may allow the position of the gripping members to be adjusted to accommodate a variety of mobile devices of different sizes.

In another aspect of the invention, the gripping members may include a corner holder that may include a corner strap to hold at least one corner of a mobile device to the device stand.

In another aspect of the invention, the device stand may include safety bumpers that may protect a mobile device when it is attached to the device stand. These safety bumpers may extend beyond the face of the mobile device when the mobile device is attached to the device stand such that if the device stand falls upon a hard surface the bumper may prevent the face of the mobile device from coming into contact with the hard surface.

Another aspect of the invention regards the safety bumpers being attached to the corner holders.

In another aspect of the invention, the safety bumpers are attached to or formed as a part of the device stand.

In another aspect of the invention, the safety bumpers may act as the gripping members for securing the mobile device to the device stand. In this aspect, the corner straps on the corner holders may or may not be necessary.

In another aspect of the current invention, the safety bumpers or the corner holders may have a V-notch to accommodate and secure the corner of a mobile device while it is being attached to the device stand.

In another aspect of the current invention, the safety bumpers or the corner holders may have front edges of a V-notch that may accommodate the sides of a mobile device while it is being attached to the device stand. In this aspect, the gripping members may secure the sides of the mobile device to the device stand instead of the corners. A combination of sides and corners of the mobile device may also be secured to the stand.

In yet another aspect of the current invention, the gipping member or safety bumper may be bent backward to expose the corner or side of the mobile device in order to allow the mobile device to be inserted into the gripping member for attachment of the mobile device to the device stand, and disengaged and removed from the gripping member in order to be removed from the device stand.

In yet another aspect of the current invention, the gipping member or safety bumper may be folded backward to expose the corner or side of the mobile device in order to allow the mobile device to be inserted into the gripping member for attachment of the mobile device to the device stand, and disengaged and removed from the gripping member in order to be removed from the device stand.

In yet another aspect of the current invention, the gipping member or safety bumper may be rotated to expose the corner or side of the mobile device in order to allow the mobile device to be inserted into the gripping member for attachment of the mobile device to the device stand, and disengaged and removed from the gripping member in order to be removed from the device stand.

In yet another aspect of the invention, an adapter plug may be inserted into the gripping member in order to decrease the amount of overlap the gripping member may have on the surface of the mobile device in order to not obscure any usable portion of the mobile device's touch screen.

In another aspect of the invention, the device stand may fold up into a carrying case in order to safely transport the mobile device.

In yet another aspect of the invention, a speaker horn may be attached to the device stand in order to increase the volume and fidelity of the sound emanating from the rear speaker of a mobile device that may be attached to the device stand.

### BRIEF DESCRIPTION OF THE DRAWINGS

FIG. 1 is a front view of a stand with a mobile device attached.

FIG. 2A is s front view of a stand with a mobile device attached.

FIG. 2B is a rear view of a mobile device stand.

FIG. 2C is a front view of a stand upright with a mobile device attached.

FIG. 3A is a front view of a stand with a mobile device attached.

FIG. 3B is a rear view of a mobile device stand.

FIG. 3C is a front view of a stand upright with a mobile device attached.

FIG. 3D is a side view of a stand with a rectangular block section.

FIG. 3E is a perspective view of a stand with a rectangular block section.

FIG. 4 is a front view of a stand with a handle and a mobile device attached.

FIG. 5 is a rear view of a mobile device stand with a pocket.

FIG. 6 is a view of the front face of a mobile device stand.

FIG. 7A is a top view of a mobile device corner holder.

FIG. 7B is a side view of a mobile device corner holder.

FIG. 7C is a top view of a corner holder attached to the corner of a mobile device.

FIG. 7D is a top view of a mobile device attached to a stand using corner holders.

FIG. 7E is a top view of a mobile device attached to a stand using corner holders.

FIG. 8A is a side view of a stand with a mobile device secured using corner bumpers.

FIG. 8B is a side view of a stand with bumpers extending downward.

FIG. 9A is a top view of a bumper attached to a corner holder.

FIG. 9AA is a top view of a bumper attached to a corner holder.

FIG. 9B is a side view of a bumper attached to a corner holder.

FIG. 9BB is a top view of a bumper with a mobile device.

FIG. 9C is a top view of a mobile device being held by a bumper.

FIG. 9CC is a top view of a bumper with a mobile device.

FIG. 9D is a top view of a corner bumper bending backwards.

FIG. 9E is a side view of a corner bumper folding upward.

FIG. 9F is a top view of a corner bumper rotating sideways.

FIG. 9G is a top view of a bumper rotating sideways.

FIG. 9H is a front view of a mobile device attached to a stand.

FIG. 9I is a front view of a mobile device attached to a stand.

FIG. 9J is a front view of an adapter plug.

FIG. 9K is a top view of a bumper with an adapter plug.

FIG. 9L is a side view of a bumper with an adapter plug.

FIG. 9M is a side view of a bumper without an adapter plug.

FIG. 9N is a top view of a bumper with an adapter plug and a mobile device.

FIG. 10A is a front view of a mobile device carrying case closed.

FIG. 10B is a side view of a mobile device carrying case closed.

FIG. 10C is a side view of a mobile device carrying case opened.

FIG. 10D is a side view of a mobile device carrying case folded into a stand.

FIG. 11A is a perspective view of a speaker horn.

FIG. 11B is a front view of a speaker horn and a device stand.

FIG. 11C is a front view of a speaker horn inserted into a device stand.

### DETAILED DESCRIPTION OF THE PREFERRED EMBODIMENTS

In one embodiment of the invention, the device stand may be comprised of a foam material or other material. The foam material may have a shape of a pyramid, a wedge or other similar shape such that a mobile device such as a smartphone, a tablet computer, an eReader, a personal digital assistant, a portable media player or other devices may be affixed to one surface of the shape.

It should be noted that while this specification describes the use of the device stand with mobile devices, the device stand may also be used with other products and devices such as books, magazines, or any other item that may benefit from the functionality of the device stand.

The shapes of this embodiment will now be described.

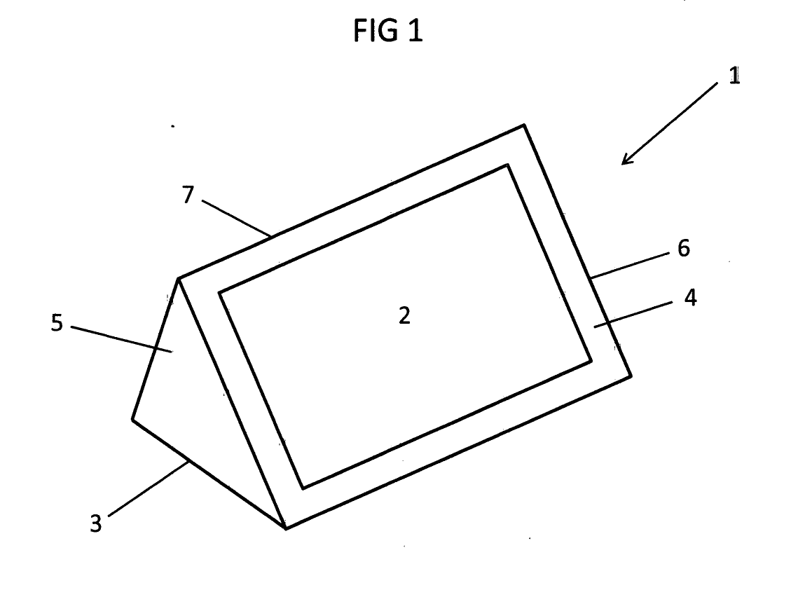

In one embodiment as shown in FIG. 1, the shape of the device stand 1 may be a wedge. The wedge shape may rest on its bottom surface 3 and the mobile device 2 may be affixed to the front slanted surface 4 of the wedge. This may allow a user to rest the device stand 1 comfortably on their lap while engaging with the attached mobile device 2. While FIG. 1 shows the mobile device 2 as being affixed to the front slanted surface 4 of the wedge, the mobile device 2 may be affixed to any surface of the wedge.

In this embodiment, the front face 4 to which the mobile device 2 may be affixed may be generally rectangular, the bottom surface 3 may also be generally rectangular, the back surface 7 (not shown) may be generally rectangular and the side surfaces 5, 6 (6 is not shown) may be generally triangular. However, each of these sides may also be other shapes.

In addition, the corners of the wedge may be rounded such that the corners of the front face 4, the bottom surface 3 and the side surfaces 5,6 may also be rounded. In this case, the front surface 4 and bottom surface 3 may not be true rectangles and the side surfaces 5,6 may not be true triangles. It is clear that these various surfaces may be other shapes than rectangles and triangles.

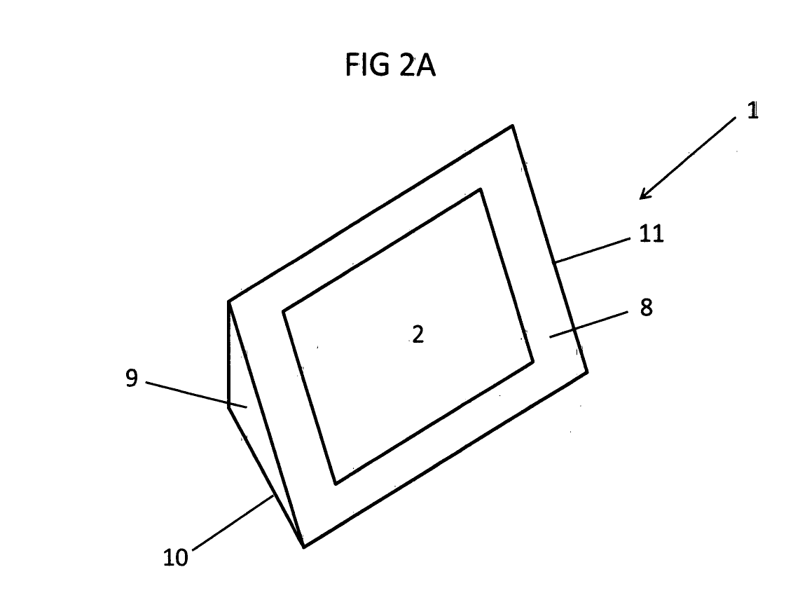

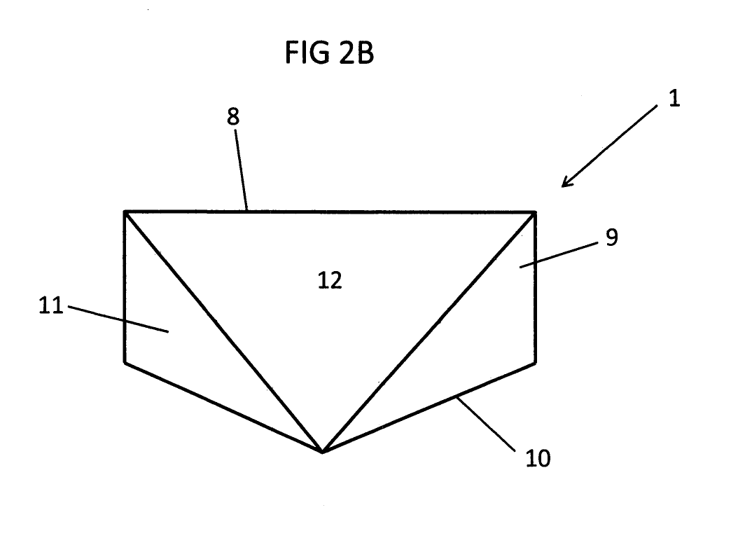

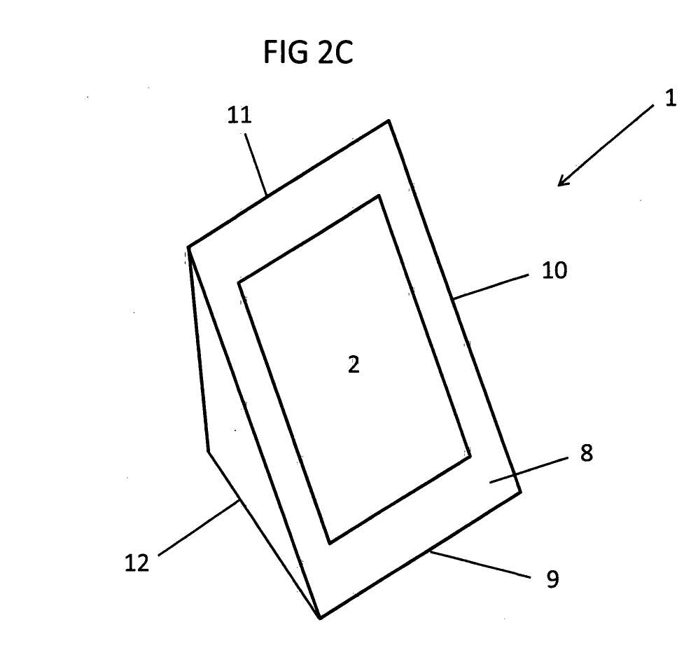

In another embodiment, the shape of the device stand 1 may be a pyramid resting on its side as shown in FIG. 2A and FIG. 2B.

In FIG. 2A, the mobile device 2 may be affixed to the generally rectangular surface 8 of the pyramid while the pyramid rests on its lower generally triangular surface 10 (not shown). The sides 9 and 11 (not shown) may also be generally triangular and the top surface 12 may also be generally triangular. While FIG. 2A shows the mobile device 2 as being affixed to the generally rectangular surface 8 of the device stand 1, the mobile device 2 may be affixed to any other surface of the device stand 1.

FIG. 2B shows the back view of the pyramid shape consisting of generally rectangular surface 8 facing away from the viewer to which the mobile device 2 may be affixed, a generally triangular side 9, a generally triangular side surface 11, a generally triangular upper side surface 12 and a generally triangular bottom side surface 10 (not shown).

As with the wedge, the corners of the pyramid may be rounded resulting in rounded corners of the pyramid such that the sides may no longer be true rectangles or true triangles.

In this embodiment, the device stand 1 may rest on any of the generally triangular sides 9,11 and still prop the mobile device 2 affixed to the generally rectangular side 8 in a slanted upright position. This allows the device stand to act as a stand for the mobile device 2 in either the landscape position as shown in FIG. 2A or in a portrait position as shown in FIG. 2C.

FIG. 2C depicts the device stand 1 resting in the portrait position such that it rests on the generally triangular side 9 (not shown) instead of the generally triangular side 10 (not shown). The shape of the device stand 1 may be designed so that it preferably does not tip over in either landscape or portrait position when the mobile device 2 is attached.

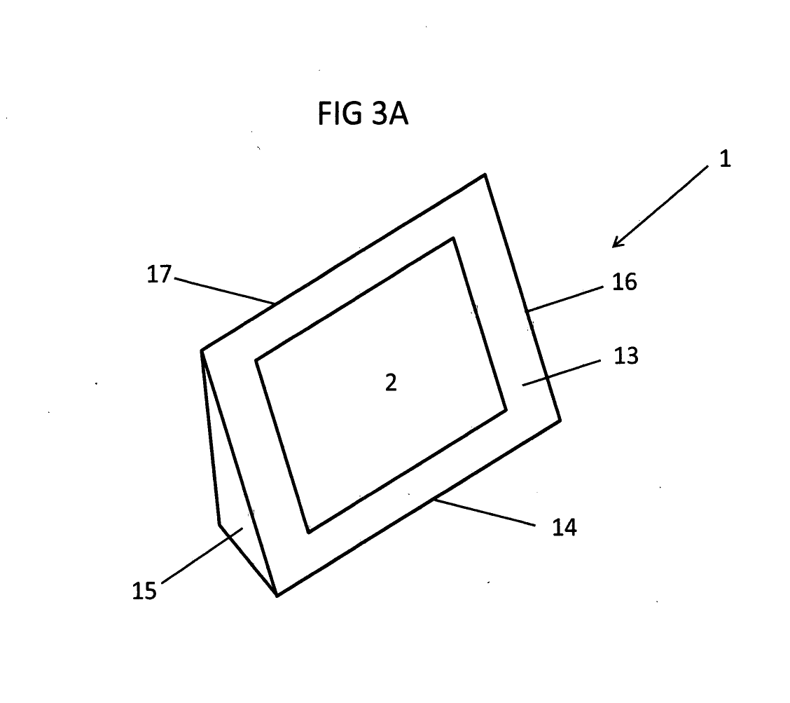

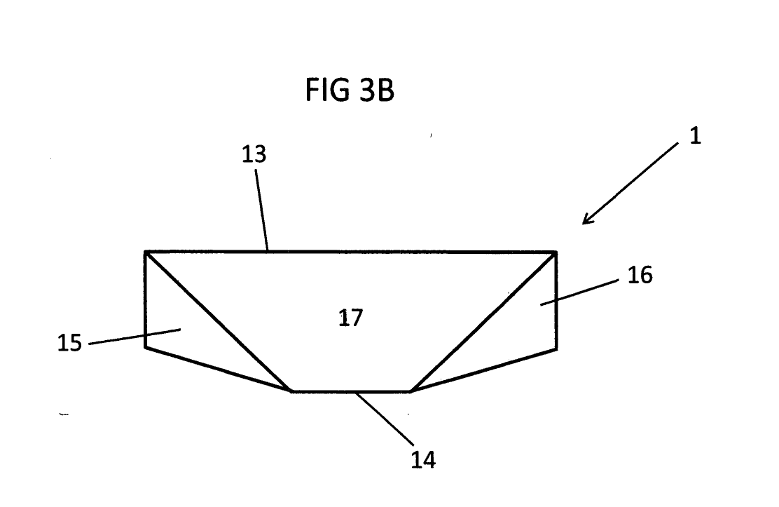

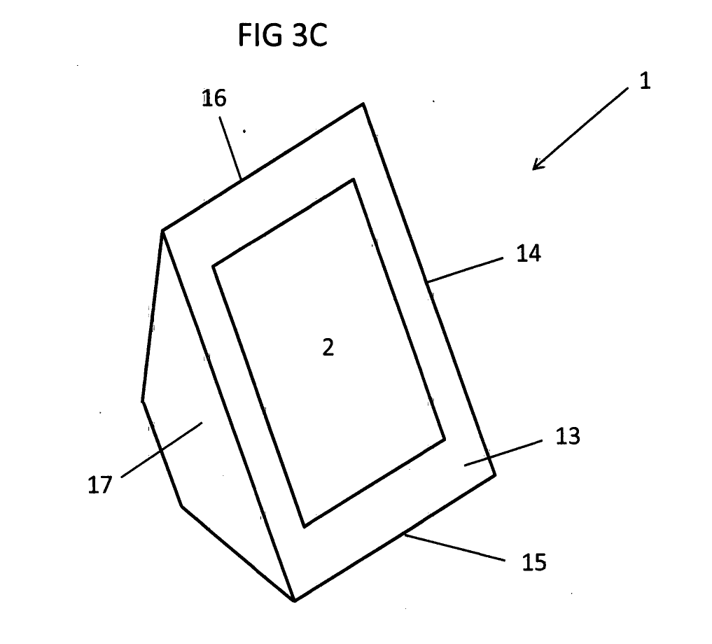

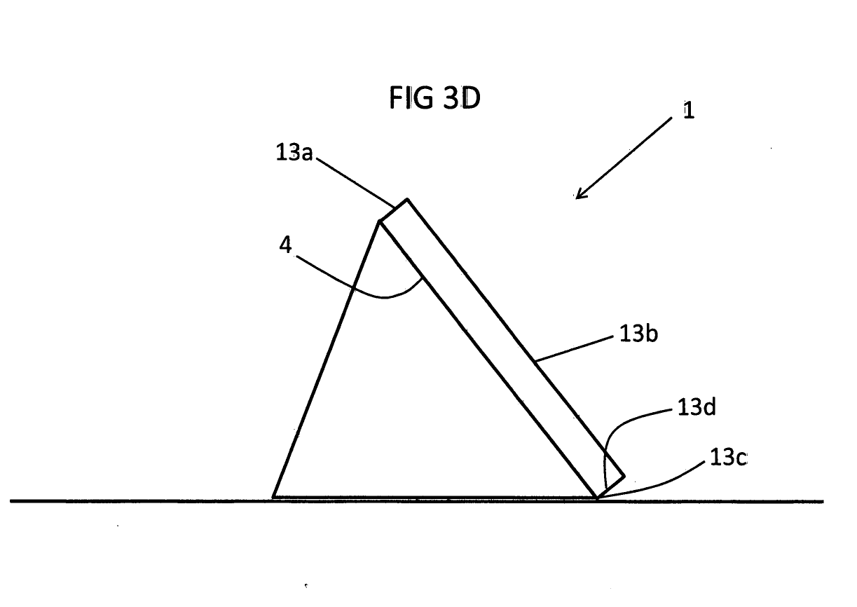

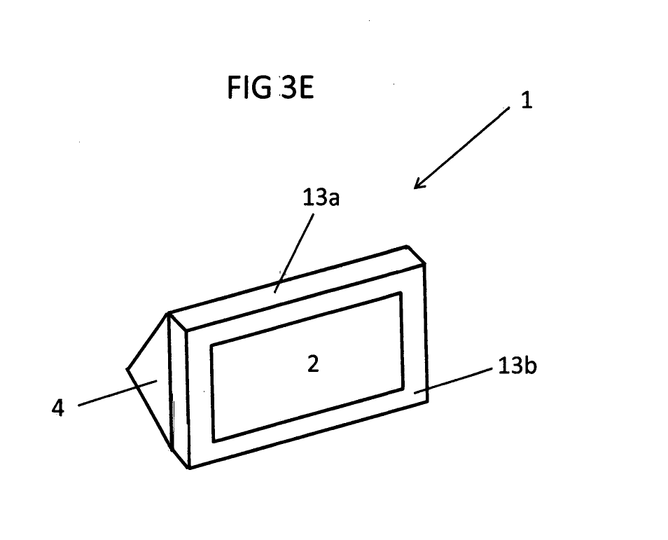

In another embodiment as shown in FIG. 3A, FIG. 3B and FIG. 3C, the shape of the device stand 1 may be a hybrid of the wedge shape and the pyramid shape embodiments described above.

In this embodiment as shown in FIG. 3A, the mobile device 2 may be affixed to the generally rectangular front surface 13 while the device stand 1 rests on the generally trapezoidal bottom surface 14 (not shown) of the hybrid shape. While FIG. 3A shows the mobile device 2 as being affixed to the generally rectangular front surface 13 of the hybrid shaped device stand 1, the mobile device 2 may be affixed to any surface of the device stand 1.

FIG. 3B shows the back view of the hybrid shape consisting of a generally trapezoidal upper surface 17, a generally trapezoidal lower surface 14 (not shown), a generally triangular side surface 15, a generally triangular side surface 16 and a generally rectangular surface 13 (not shown) to which the mobile device 2 may be affixed.

As with the wedge and pyramid shapes, the corners of the hybrid shape may be rounded resulting in rounded corners of the sides of the hybrid shape such that the sides are no longer true rectangles, true trapezoids or true triangles.

In this embodiment, the device stand 1 may rest on any of the generally trapezoidal surfaces 17,14 or any of the generally triangular surfaces 15,16 and prop the mobile device 2 affixed to the generally rectangular side 13 in a slanted upright position. This allows the device stand 1 to act as a stand for the mobile device 2 in either the landscape position as shown in FIG. 3A or in a portrait position as shown in FIG. 3C.

FIG. 3C depicts the device stand 1 resting in the portrait position such that it rests on the generally triangular side 15 (not shown) instead of the generally triangular side 14 (not shown). The shape of the device stand 1 may be designed so that it preferably does not tip over in either landscape or portrait position when the mobile device 2 is attached.

While FIG. 3A, FIG. 3B and FIG. 3C show the mobile device 2 as being affixed to the generally rectangular side 13 of the device stand 1, the mobile device 2 may be affixed to any side of the device stand 1.

While the embodiments described above depict the device stand 1 as being a generally wedge shape, a generally pyramid shape or a hybrid of the wedge shape and the pyramid shape, the device stand 1 may also be other shapes or combination of shapes that may result in similar functionality.

In addition, the embodiments described above in relation to FIGS. 1, 2A, 2B, 2C, 3A, 3B and 3C may also have a rectangular block section that may be attached to, or a part of, and extend away from the front surface of the device stand 1 to which the mobile device 2 may be attached. This is shown in FIGS. 3D and 3E.

FIG. 3D shows a side view of the wedge shaped device stand 1 described in relation to FIG. 1 with rectangular block section 13a attached to and extending away from the front surface 4 of the wedge. FIG. 3E shows a perspective view of the same embodiment with a mobile device 2 attached to the front face 13b of the rectangular block section 13a. The rectangular block section 13a may be formed as a part of the foam or other material comprising the device stand 1 or may be a separate component that may be attached to the front face 4 of the device stand 1.

The purpose of the rectangular block section 13a may be to cause the device stand 1 of FIGS. 3D and 3E to be more stable when a mobile device 2 is attached to the front face 13b of the rectangular block section 13a compared to the device stand 1 of FIG. 1 when a mobile device 2 is attached to the front face 4 of the wedge. The rectangular block section 13a depicted in FIGS. 3D and 3E may shift the position of the center of gravity of the device stand 1 and mobile device 2 combination to a more stable position while adding mass to the front of the device stand 1. The lower front edge 13c of the device stand 1 depicted in FIGS. 13D and 13E may also not be as sharp as the lower front edge of the wedge shaped device stand 1 depicted in FIG. 1 due to the straight lower surface 13d of the rectangular block section 13a as shown. This less sharp lower front edge 13c may help the device stand 1 depicted in FIGS. 3d and 3E to be less prone to tipping over forward.

While the rectangular block section 13a has been described in relation to the embodiment of FIG. 1, it may also be included in the embodiments described with reference to FIGS. 2A, 2B, 2C, 3A, 3B, 3C as well as any other embodiments described in this specification.

Also, while the description above of the rectangular block section 13a described the block section 13a as being generally rectangular in shape, other shapes may also be used such as trapezoids, triangles and other shapes. In addition, while FIGS. 3D and 3E depict the rectangular block section as being generally the same size and shape as the side 4 from which it may extend, it may also be not the same size and shape as the side 4 from which it may extend and instead may be of different shapes and sizes compared to side 4. The rectangular block section 13a may also be attached to or formed as a part of other sides of the device stand 1.

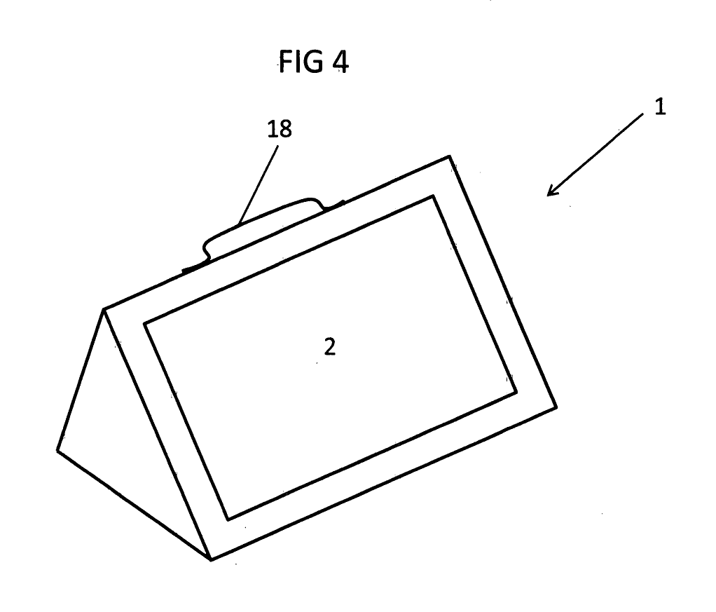

The device stand 1 may also include a carrying handle that may allow the device stand 1 to be carried by hand by easily gripping the handle. This is depicted in FIG. 4. While the handle is shown to be located on the top of the generally rectangular side to which the mobile device 2 may be affixed, the handle may also be located in any other position on the device stand 1 where it is functional.

While FIG. 4 depicts the device stand 1 as being the wedge shape, any shaped device stand 1 may include a handle.

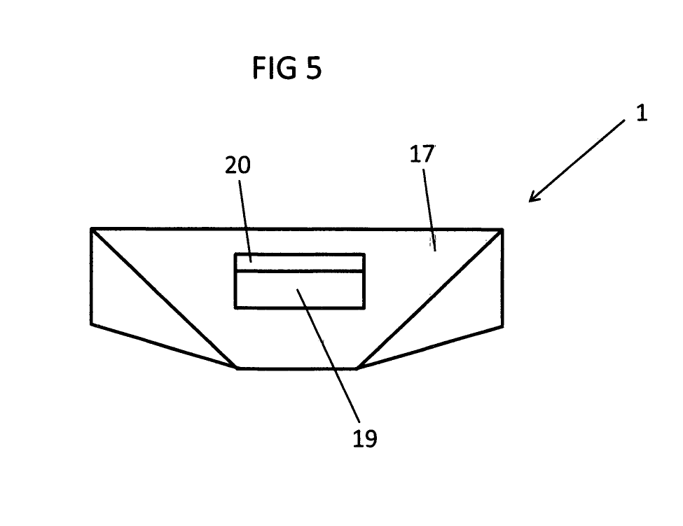

In addition, the device stand 1 may include a pocket that may allow the storage of items such as dust cloths, mobile device chargers, etc. This is depicted in FIG. 5. The pocket may also have a flap 20 that may close to hold the contents inside the pocket securely. The flap may utilize Velcro, buttons, snaps, zippers or other means to lock in place.

While the pocket is shown to be located on the face of the generally trapezoidal side 17 of the hybrid shaped device stand 1 of the above embodiment, the pocket may also be located in any other position on the device stand 1 where it is functional.

While FIG. 5 depicts the device stand 1 as being the hybrid shape of the above embodiment, any shaped device stand 1 may include a pocket.

The foam material described in the above embodiments may also be covered in a fabric to make the device stand more comfortable to hold. However, the foam does not necessarily need to be covered in a soft material and may or may not have a skin on the foam to protect it from damage, dirt and debris. If the foam is covered in a fabric, the fabric may be removable in order to clean it.

While the device stand 1 as described in the above embodiments are described as being made of foam, other materials such as rubber or other materials may also be used. The device stand 1 may also comprise of a fabric cover sewn into the shapes described in the embodiments above and then filled with stuffing materials such as feathers, Styrofoam beads, synthetic pillow stuffing or other stuffing materials.

Also, the size of the device stand 1 may vary depending on the size of the mobile device 2 that it may be designed to accommodate. For instance, because some tablet computes may be larger than some eReaders, device stands 1 designed to accommodate tablet computers may be designed to be larger than device stands 1 designed to accommodate eReaders.

The way that the mobile device may be affixed to one of the surfaces of the device stand 1 will now be described.

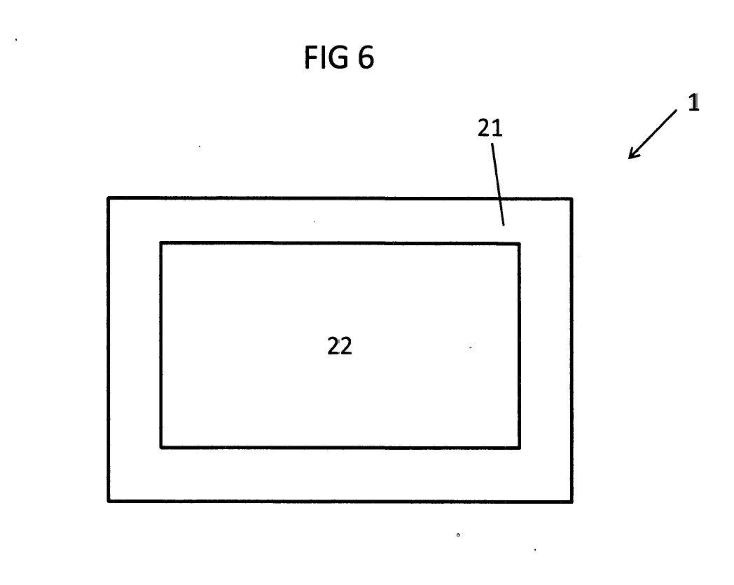

FIG. 6 shows the surface 21 of the device stand 1 to which the mobile device 2 (not shown) may be affixed. The surface 21 may include a sheet of Velcro 22 (or other brand hook and loop product) that is attached to the face of the surface 21. This sheet of Velcro 22 may be designed to allow the attachment of other components to the sheet of Velcro 22 in various positions on the sheet 22. The sheet of Velcro 22 attached to the surface 21 may be a hook or a loop side of Velcro 22. If the Velcro sheet 22 is a hook side, the other components that may be attached to it may include a loop side in order to attach. If the Velcro sheet 22 is a loop side, the other components that may be attached to it may include a hook side in order to attach. It should be noted that surface 21 may generally represent the front face of the device stand 1 in FIG. 6, as does also surface 4 in FIG. 1, surface 8 in FIG. 2A, surface 13 in FIG. 3A, and surface 13b in FIG. 3D. It should also be noted that while FIG. 6 depicts only one side 21 of the device stand 1 as having a Velcro sheet 22 attached to it, multiple sides may have Velcro sheets 22 attached to them such that other components may be attached to multiple side at the same time or individually.

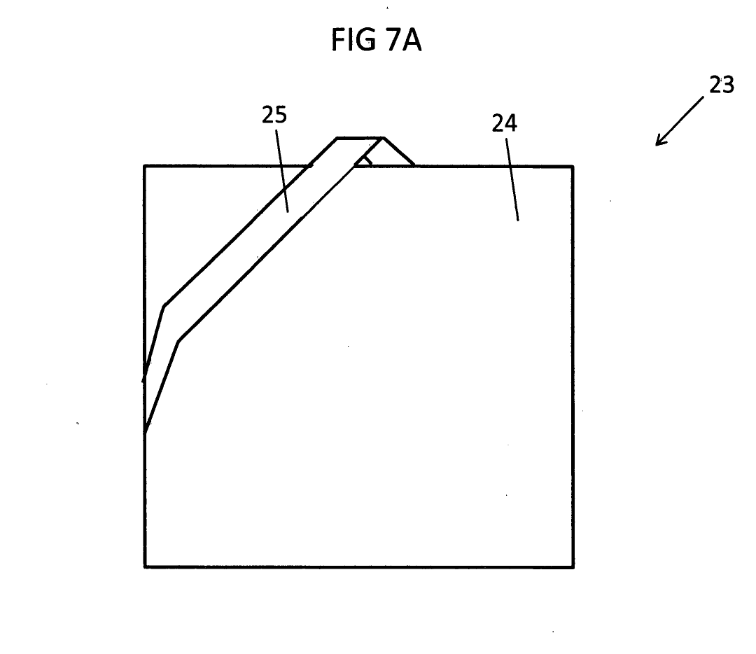

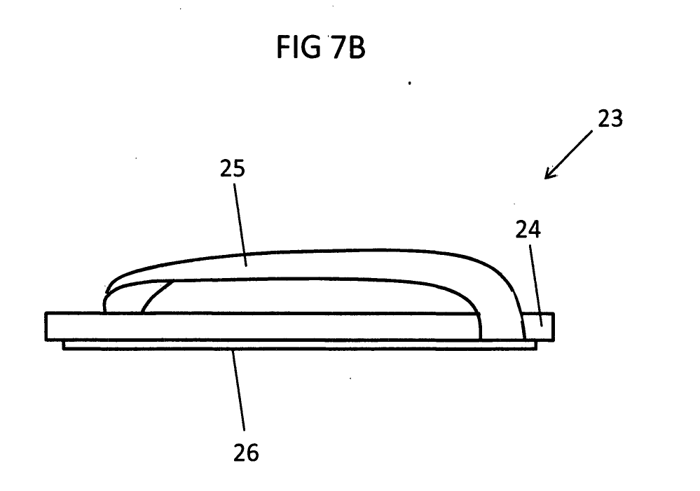

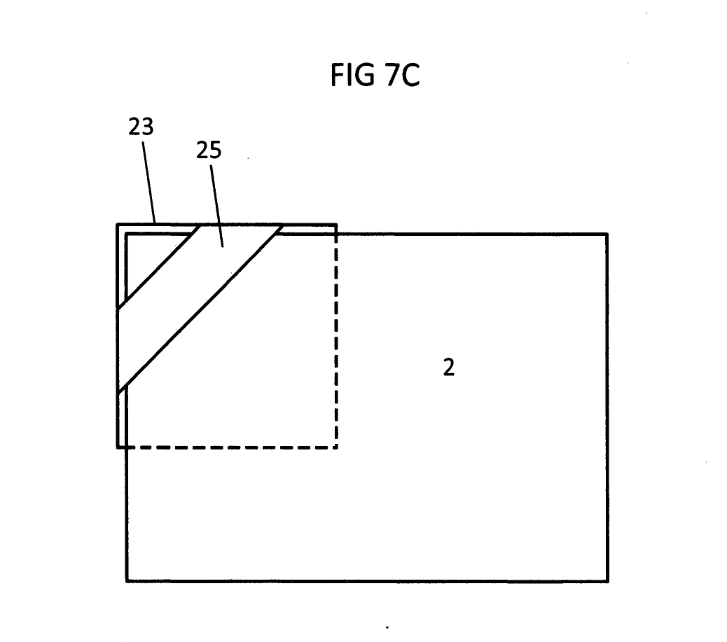

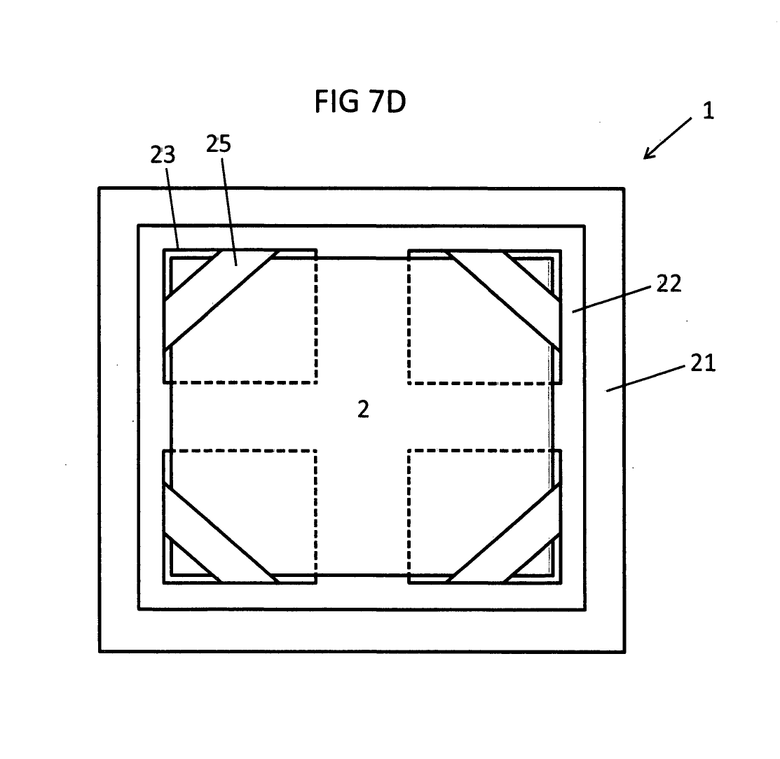

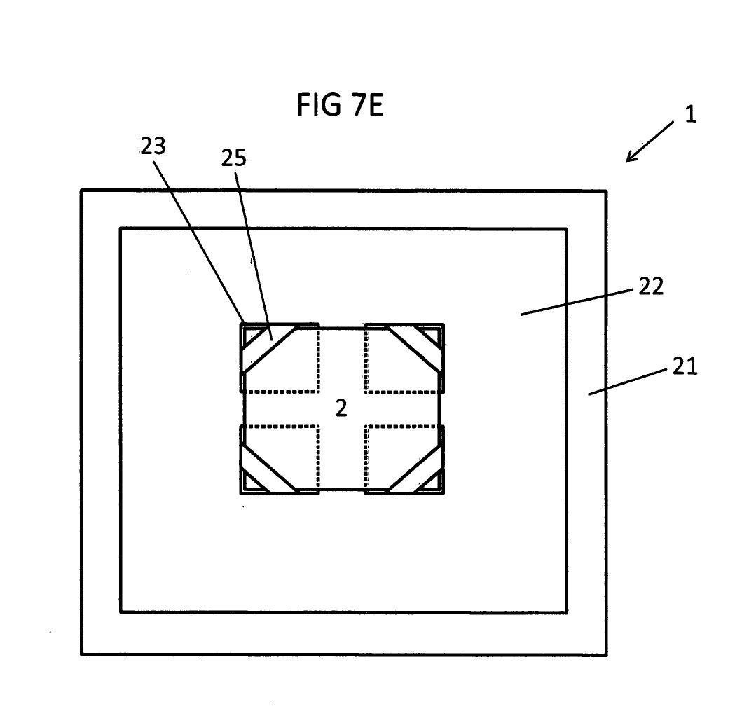

One such component that may be attached to the Velcro sheet 22 that may hold the mobile device 2 in place may be a gripping member. As shown in FIGS. 7A and 7B, one such type of gripping member may be a corner holder 23.

Corner holder 23 may be comprised of a bottom section 24 that may have a strap 25 attached across the corner section of the corner holder 23 as shown in FIG. 7A and FIG. 7B. Bottom section 24 may be comprised of plastic, rubber, wood, or other materials. Note that while bottom section 24 in 7A is depicted to be generally square, bottom section 24 of corner holder 23 may be other shapes such as triangular, oval shaped, rectangular or other shapes.

As shown in FIG. 7B, the corner holder 23 may also have a sheet of Velcro 26 on its bottom surface that it may be attached to the Velcro sheet 22 that may be attached to the surface 21 of FIG. 6.

The Velcro sheet 26 on the bottom of the corner holder 23 may be chosen to be the hook-type of Velcro while the Velcro sheet 22 on the face of surface 21 of the device stand 1 may be chosen to be the loop-type of Velcro. Thus the Velcro sheet 26 may be pressed onto the Velcro sheet 22 resulting in the secure attachment of the corner holder 23 onto the device stand 1.

Conversely, the Velcro sheet 26 on the bottom of the corner holder 23 may be chosen to be the loop-type of Velcro while the Velcro sheet 22 on the face of surface 21 of the device stand 1 may be chosen to be the hook-type of Velcro in order to secure the corner holder 23 to the device stand 1.

The strap 25 of the corner holder 23 may be designed such that the corner of the mobile device 2 may be slipped under the corner strap 25 of the corner holder 23 as shown in FIG. 7C.

Also, the strap 25 may comprise an elastic material or may comprise a non-elastic material.

The corner holder 23 may be used to affix the mobile device 2 to the device stand 1 by slipping the corner of the mobile device 2 under the corner strap 25 of the corner holder 23 and then attaching the corner holder 23 to the device stand 1 as described above.

Preferably, more than one corner holder 23 may be used to affix more than one corner of the mobile device 2 to the device stand 1 in order to securely attach the mobile device 2 to the device stand 1.

FIG. 7D shows a mobile device 2 attached to a device stand 1 using four corner holders 23. Each corner of the mobile device is held by the corner strap 25 of one corner holder 23 and the Velcro sheet 26 on each corner holder 23 is affixed to the Velcro sheet 22 attached to the face 21 of the device stand 1.

While FIG. 7D shows all four corners of the mobile device held by corner holders 23, it may not be necessary for all four corners to be held in order to securely affix the mobile device 2 to the device stand 1.

The Velcro sheet 22 may be designed to be large enough to allow the attachment of at least one corner holder 23, and preferably multiple corner holders 23, that may also be attached to the corners of a mobile device 2 as described above. Because mobile devices on the market are all different sizes, it may be preferable to have the Velcro sheet 22 designed to be large enough to accommodate a wide variety of sizes and to allow the attachment of corner holders 23 in a wide variety of positions in order to attach the mobile devices 2 of different sizes.

For example, while FIG. 7D depicts a device stand 1 as having the corner holders 23 being positioned on the Velcro sheet 22 to secure a large mobile device 2 to the device stand 1, FIG. 7E depicts a device stand 1 as having the corner holders 23 being positioned on the Velcro sheet 22 to secure a smaller mobile device 2 to the device stand 1.

While Velcro is described in the above embodiments as the attachment means to attach the corner holders 23 to the device stand 1, other attachment means such as a grid of snaps, a grid of jacks, or other attachment means may also be employed with a similar result.

Also, it may be preferable to design the width of the corner bumpers 23 to be small enough to allow two corner bumpers to rest side-by-side to hold two corners of the mobile device 2 without the corner holders 23 overlapping.

If the device stand1 was to fall and land with the attached mobile device 2 facing upward, the device stand 1 may absorb the shock resulting from the fall and the mobile device 2 may be protected. However, if the device stand1 was to fall and land on a hard surface with the mobile device 2 facing downward, the device stand 1 may require additional safety features in order to protect the attached mobile device 2.

In order to provide protection to the mobile device 2 if the device stand1 was to fall and land on a hard surface with the mobile device 2 facing downward, the device stand1 may also comprise safety bumpers that may be designed to keep the mobile device 2 from hitting the ground and that may absorb the impact resulting from a fall onto a hard surface.

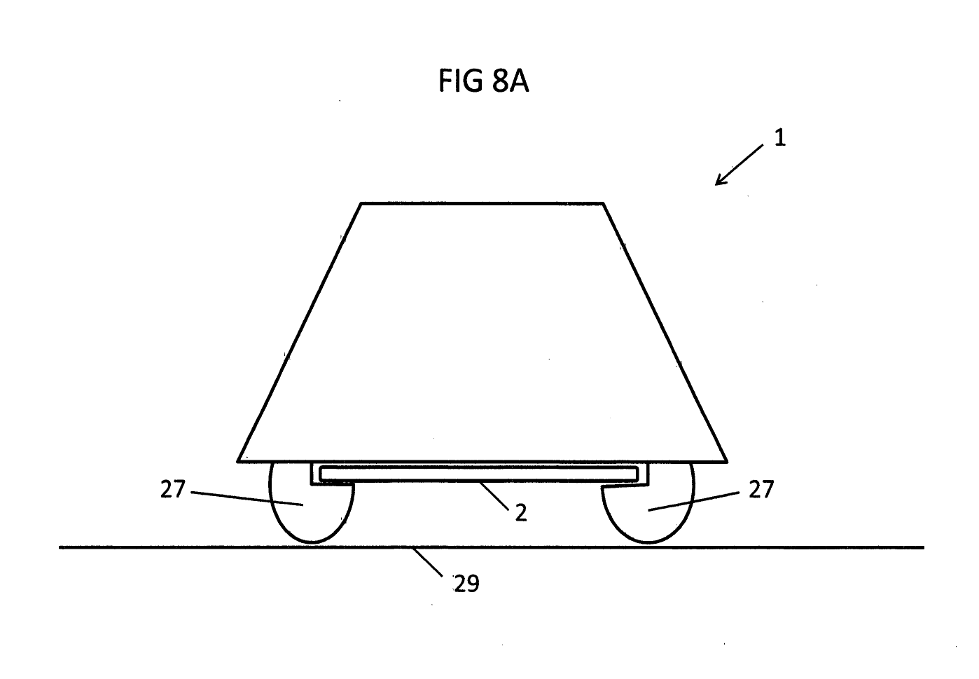

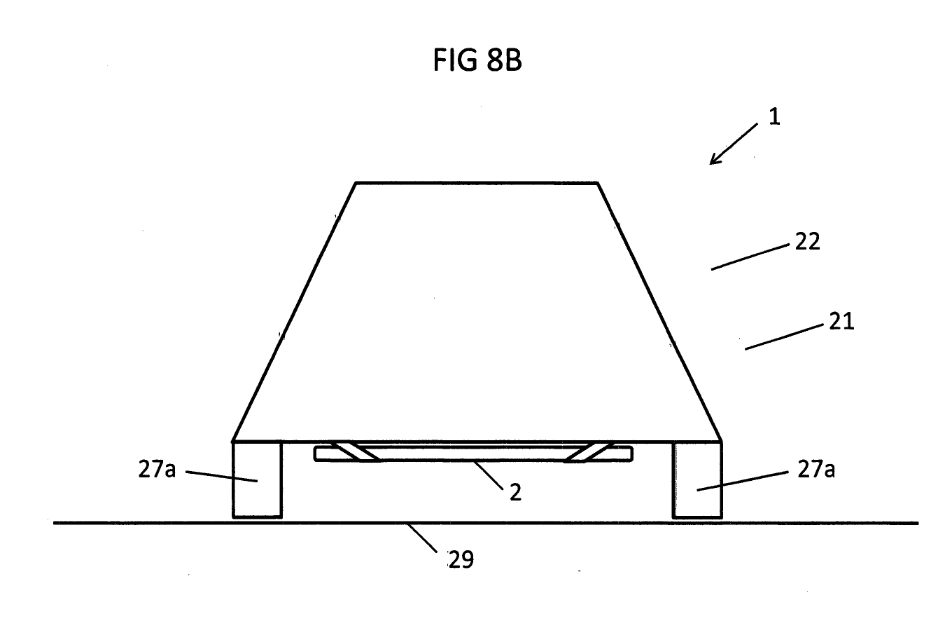

In one embodiment as shown in FIG. 8A and FIG. 8B, the device stand1 may comprise of safety bumpers 27, 27a that may be in positions and may have height and width dimensions such that they may extend past the front surface of the mobile device 2 attached to the device stand 1. In this embodiment, the device stand 1 may lay face down on a hard surface 29, with the attached mobile device 2 facing downward, and the bumpers 27, 27a may extend past the face down surface of the mobile device 2 and may keep the mobile device 2 from touching the hard surface 29.

FIG. 8A depicts the bumpers 27 securing the mobile device 2 to the face of the device stand 1. This will be described in further detail in later sections, but in general, the bumpers 27 may grip the corners, the sides or any other portion of the mobile device that may allow the bumpers 27 to secure the mobile device 2 to the device stand 1. Note that the bumpers 27 may or may not be incorporated into the corner holders 23 depicted in FIGS. 7A, 7B, 7C and 7D. This will also be described in later sections in more detail.

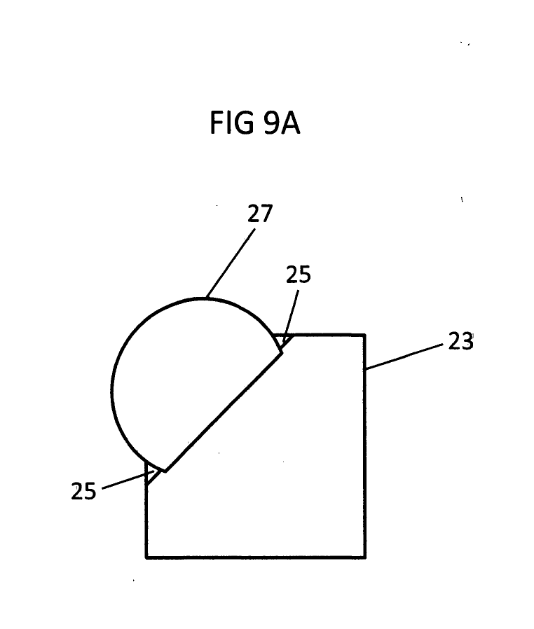

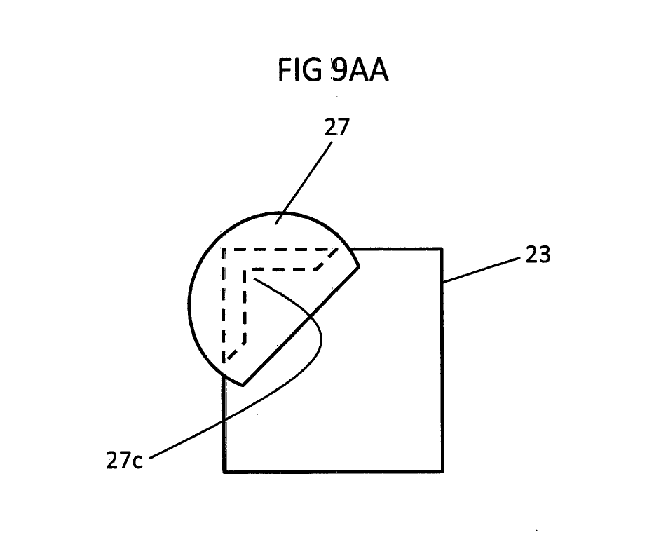

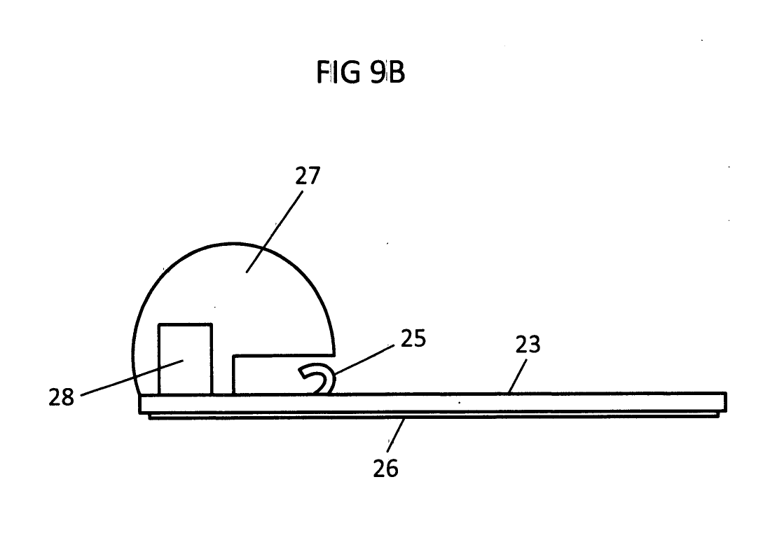

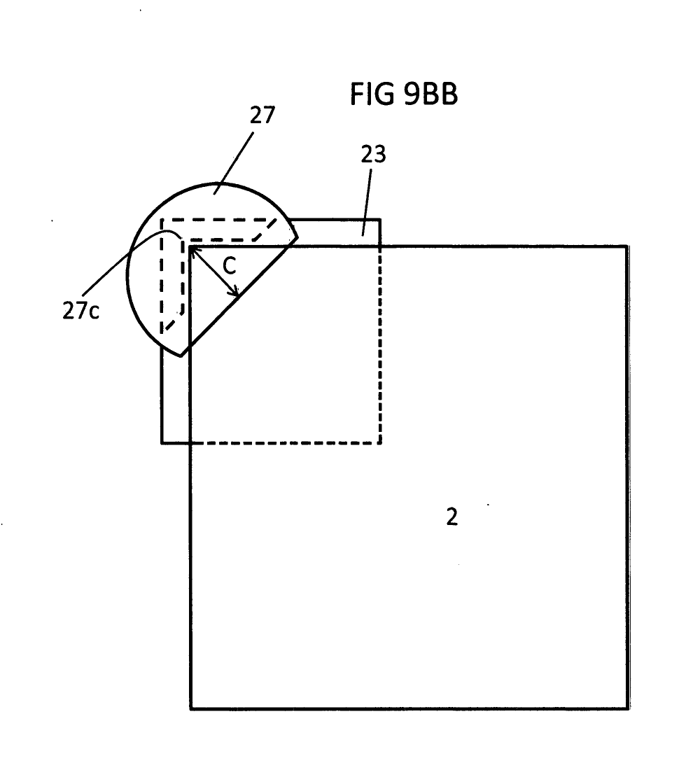

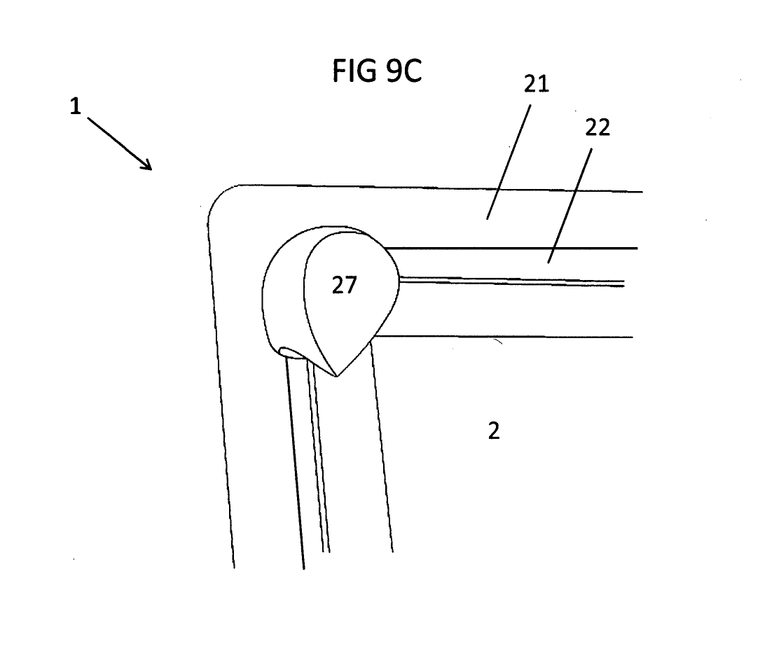

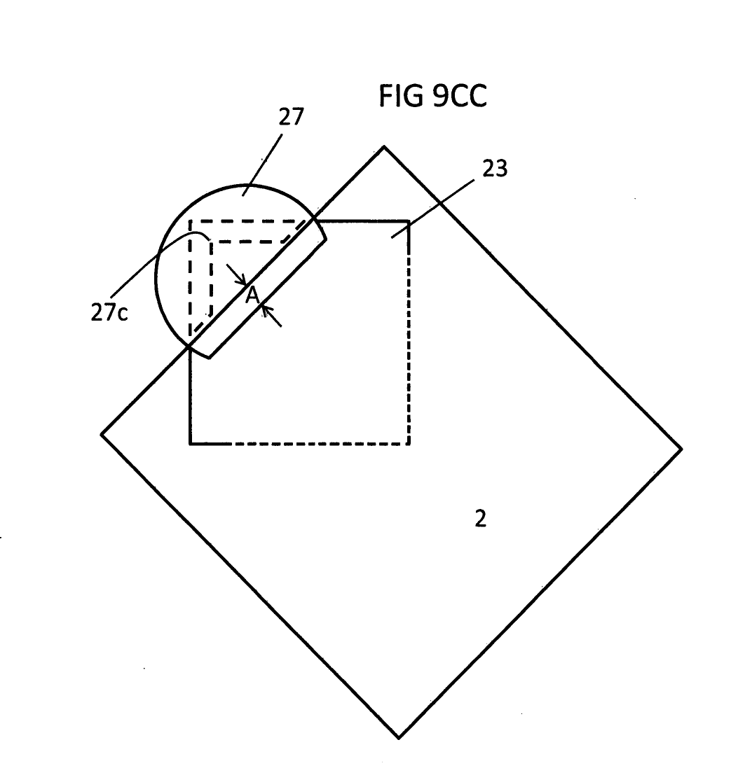

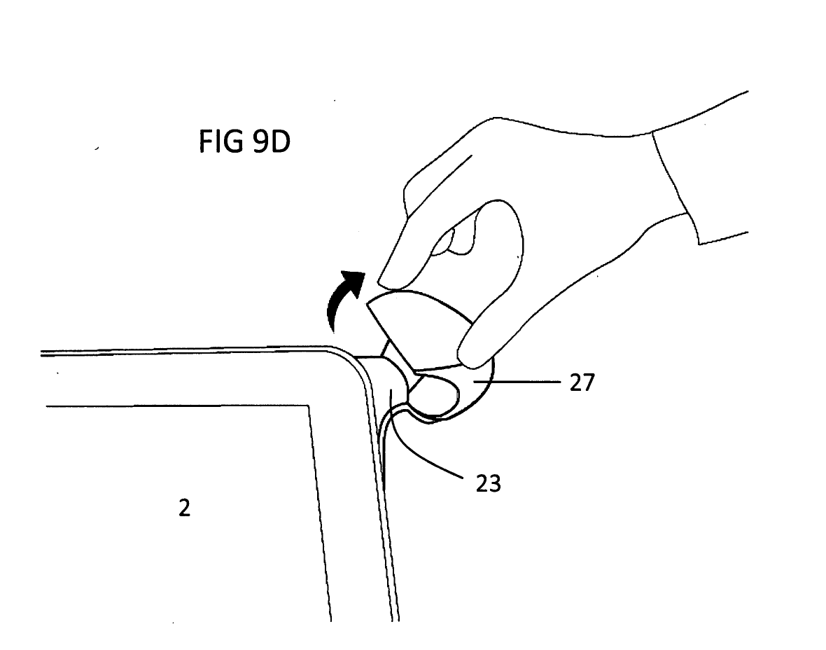

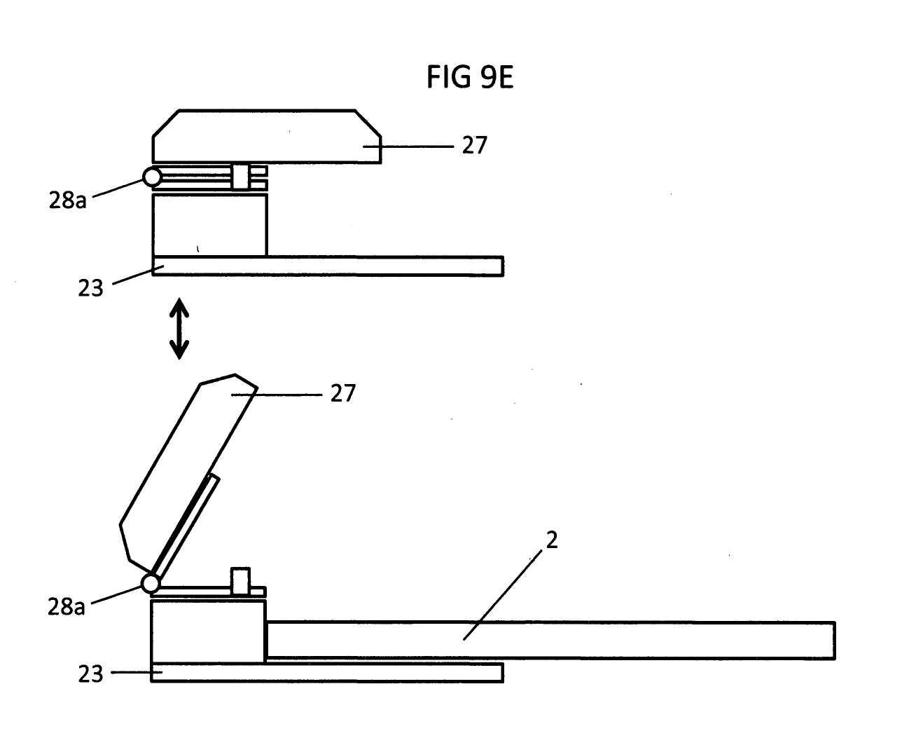

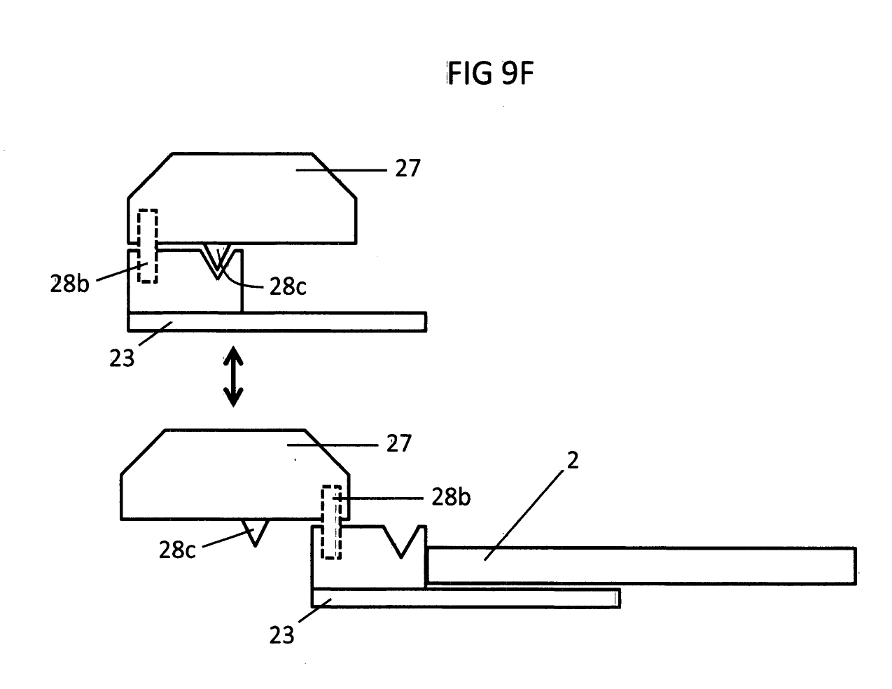

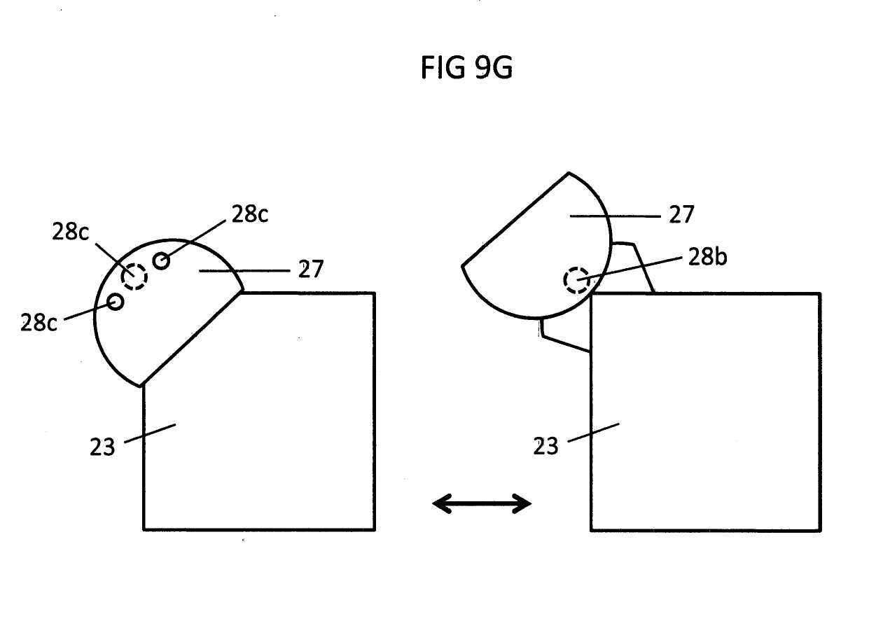

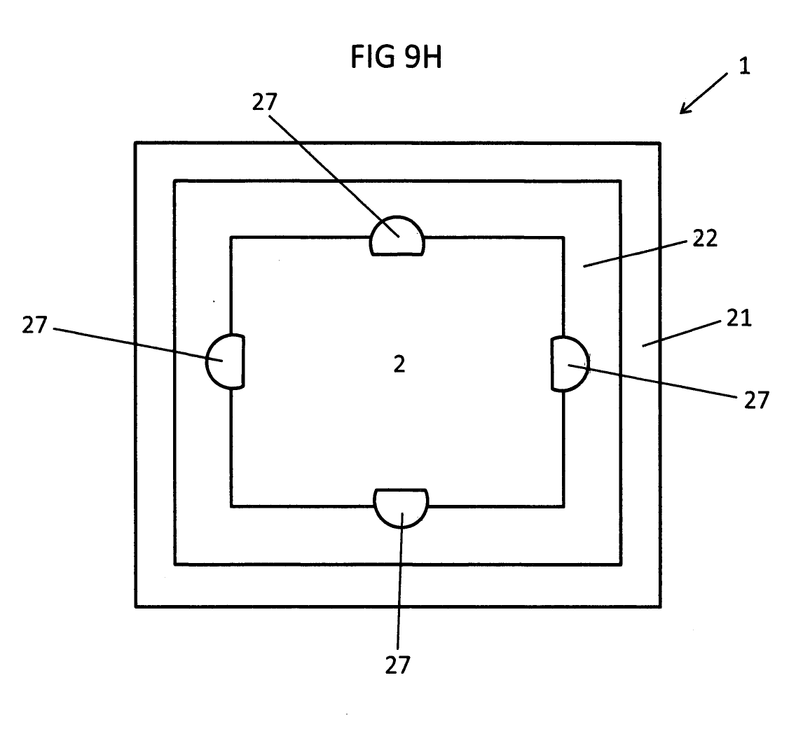

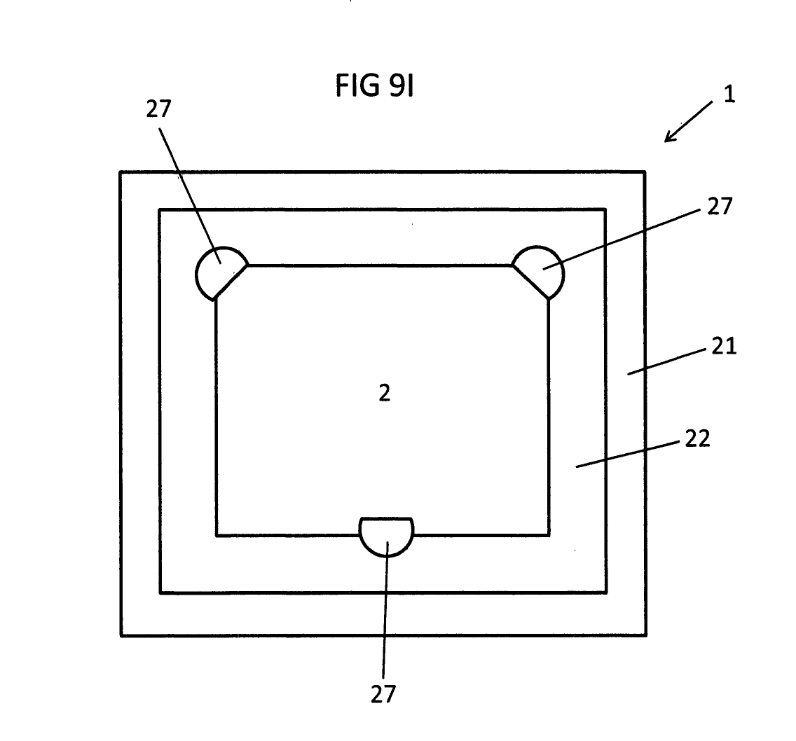

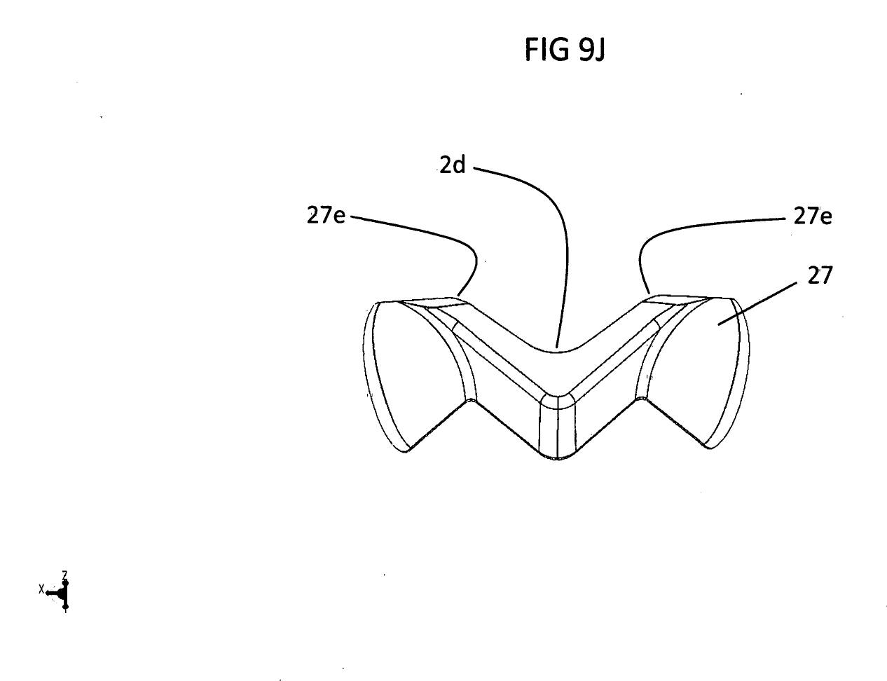

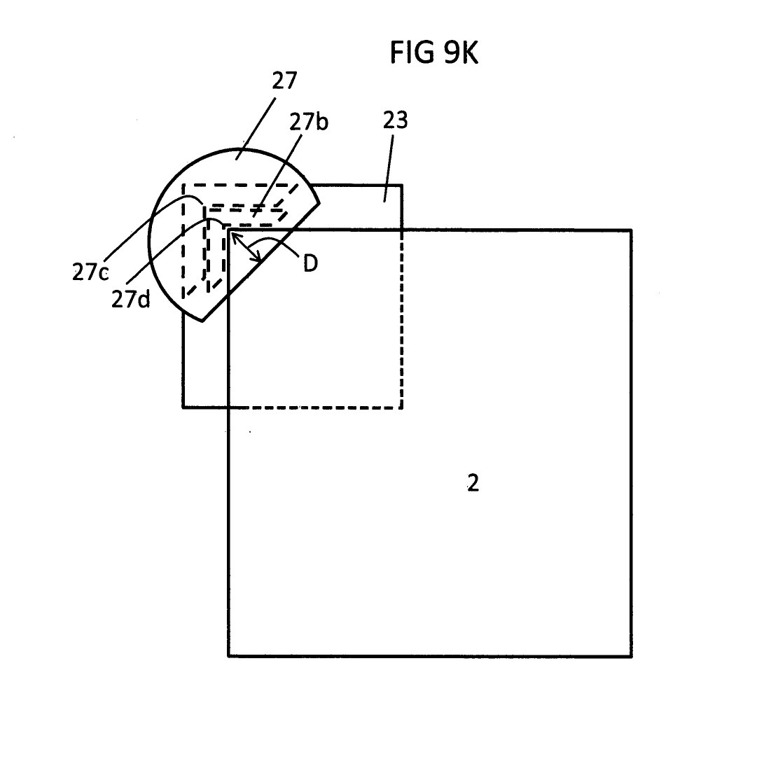

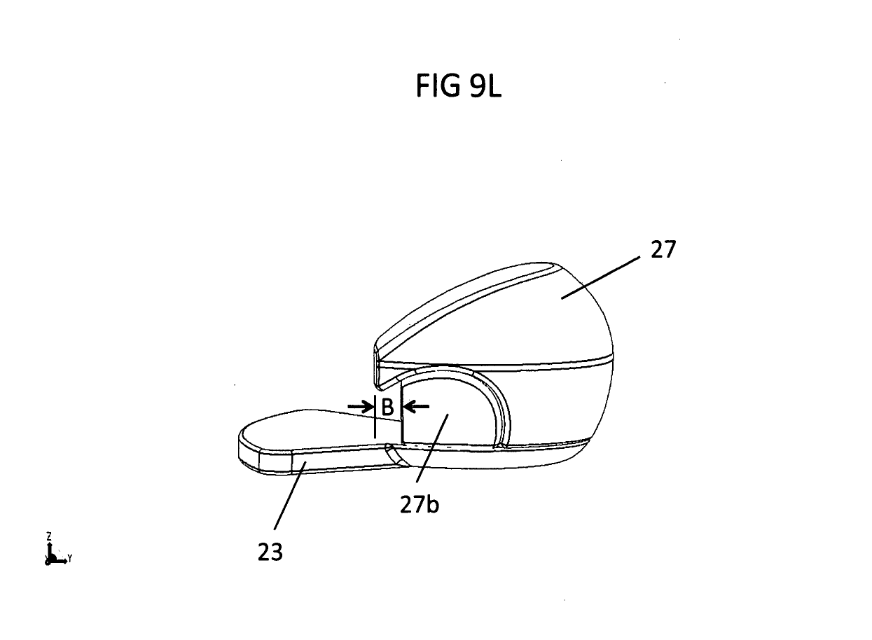

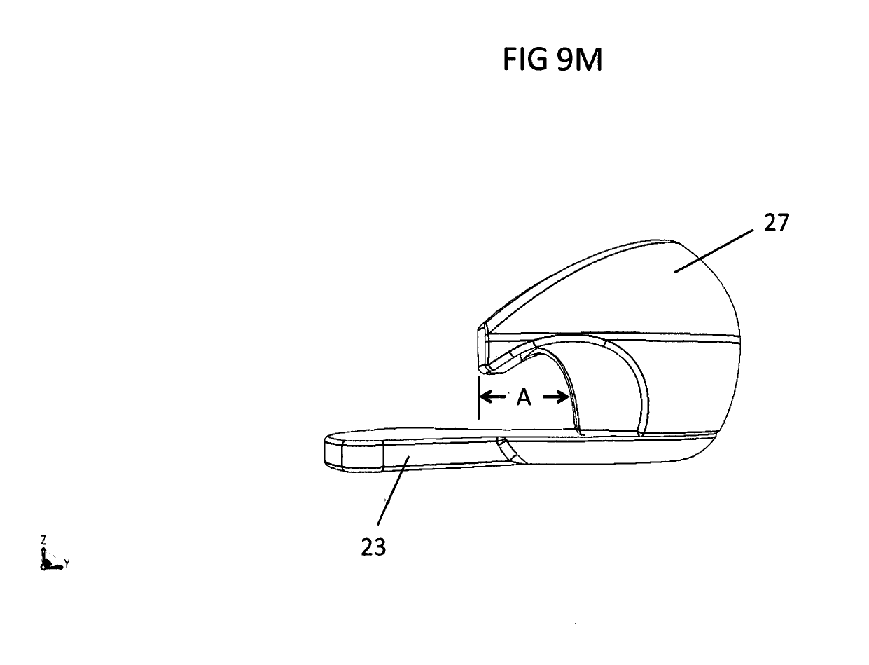

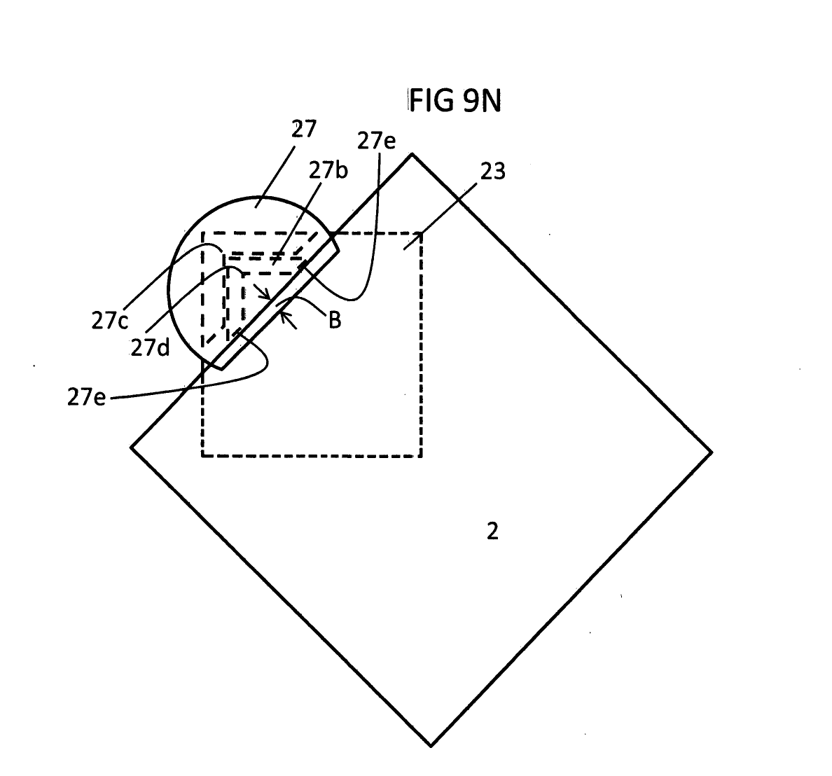

In one embodiment as shown in FIG. 9A and FIG. 9B, the safety bumpers 27 may be integrated into or formed as a part of the corner holders 23.

FIG. 9A shows the top view of a safety bumper 27 attached to the corner of the corner holder 23.

FIG. 9B shows a cutout view of the safety bumper 27 attached to the corner of the corner holder 23. In this embodiment, the corner holder 23 may include a base 28 that the safety bumper 27 may be attached to. While FIG. 9B depicts the bumper 27 as being attached to the corner holder 23 by means of base 28, other means may also be used. For instance, the bumper 27 may be attached to the corner holder strap 25, to the top surface of the bottom section 24 of the corner holder 23 or in other locations.

While FIG. 9B shows the base 28 as being located in the corner of the corner holder 23, the base 28 may located anywhere on the corner holder 23.

While FIG. 9B shows the bumper 27 as covering up the corner strap 25, the bumper 27 may also be designed to not cover up the corner strap 25.

While FIG. 9B shows the bumper 27 as permanently attached to the base 28 on the corner holder 23, the bumper 27 and the base 28 may be designed such that the bumper 27 may be removable from the base 28 such that the bumper 27 may be removed when not desired. In this embodiment, the bumper 27 may be affixed to the corner holder 23 using a snap, jack, Velcro or other means that allow the bumper 27 to be securely attached to the corner holder 23 and easily removed from the corner holder 23.

The safety bumper 27 may be designed to cover a portion of the corner of the mobile device 2, or may be designed not to cover any of the mobile device 2.

The bumper 27 may preferably be designed to not cover up any buttons, headphone jacks, speakers or other elements of the mobile device while the mobile device is connected to the corner holder 23 and the bumper 27. The bumper 27 is also preferably designed to not cover up any of the screen on the mobile device or otherwise interfere with the usage of the mobile device 2 while the mobile device is attached to the device stand 1.

While the bumper 27 depicted in FIGS. 9A and 9B are generally rounded crescent shapes, other shapes such as rectangular, trapezoidal, circular, oval-shaped, square, triangular, or any other shape may be used.

The bumper 27 may be preferably made of foam such as EVA or PU or foam rubber, a rubber such as PVC or any other material that will absorb the shock resulting in a blow taken to the bumper 27.

Also, with the bumpers 27 attached to the corner holders 23, the corner straps 25 of the corner holders 23 may not be necessary to hold the corner of the mobile device 2 secure, and the bumper 27 may instead be designed to hold the corner of the mobile device 2 secure. In this case, the bumper 27 may be designed to include a gripping element to hold the corner of the mobile device 2 secure without a corner strap 25.

In one embodiment of this type, the upper bumper 27 may be designed to act as the gripping member to hold the corner of the mobile device 2 secure to the corner holder 23 and thus to the device stand 1. In this embodiment, it may be preferred that the bumper 27 may be attached to the corner holder 23 but this may not be required.

As shown in FIG. 9C, this embodiment may entail the bumper 27 extending over a portion of the corner of the mobile device 2 in order to hold the corner of the mobile device 2 secure between the underneath inner surface of the front of the bumper 27 and the top surface of the corner holder 23. As depicted, bumper 27 may also be attached to the Velcro sheet 22 on the front face 21 of the device stand 1.

As shown in FIG. 9AA, bumper 27 may have a V-notch 27c that may accommodate the corner of the mobile device 2 and hold it securely. That is, when the corner of the mobile device 2 is inserted to fit snug within the V-notch 27c of the bumper 27, and the bumper 27 is held secure to the face of the device stand 1 such that it may not move, the corner of the mobile device 2 may be prevented from moving from side to side. This is depicted in FIG. 9BB. It may be preferable that two or more corners of the mobile device 2 are held within the V-notches 27c of two or more bumpers 27 attached to the device stand 1 in order to adequately secure the mobile device 2 to the device stand 1. Note that while the above description depicts the upper bumper as having the V-notch 27c that may accommodate the corner of a mobile device 2 for attachment, the V-notch 27c may also be positioned elsewhere on the corner holder 23 instead. For instance, the V-notch 27c may be a part of the corner holder 23 itself, a part of the corner holder base 28 of FIG. 9B, or a different part of the corner holder 23.

As described in above sections, FIG. 8A also shows the side view of a mobile device 2 being held by bumpers 27.

It should be noted that while the descriptions above depict the bumper 27 being used as a gripping member and securing the corners of the mobile device 2, the bumpers 27 may also secure one or more sides of the mobile device 2 as depicted in FIG. 9H.

In the case of a bumper 27 gripping the sides of a mobile device 2 instead of a corner of the mobile device 2, the inner portion of the V-notch 27c may not be utilized. Instead, and as shown in FIG. 9CC, the side of the mobile device 2 may rest snugly against the two front corners of the V-notch 27c while the mobile device 2 may be held between the underneath inner surface of the front of the bumper 27 and the top surface of the corner holder 23. It may be preferable that two or more sides of the mobile device 2 are held against the two front corners of the V-notches 27c of two or more bumpers 27 attached to the device stand 1 in order to adequately secure the mobile device 2 to the device stand 1. It should also be noted that the front edges of the V-notch 27c may also include front sides (not shown) that the side of the mobile device may come in contact with.

In addition, the bumpers 27 when used as gripping members may secure a combination of corners and sides of the mobile device as shown in FIG. 9I. Given this, it is apparent that the bumpers 27 acting as gripping members may be used in any combination of securing corners or sides of the mobile device 2.

If the bumper 27 as described in this embodiment is to act as the gripping element to hold the corner or side of the mobile device 2 to the corner holder 23, and therefore to the device stand 1, it may be desirable to have a means that allows the corner or side of the mobile device 2 to be easily disengaged from the gripping member in order to remove the mobile device 2 from the device stand 1.

It should be noted that since the corner holder 23 and bumper 27 may be attached to the device stand 1 using Velcro, that the corner holder 23 and bumper 27 may be simply removed from the face of the device stand 1 by disengaging the Velcro juncture between the components. However, this may be inconvenient to perform every time the mobile device 2 is to be removed from the device stand 1 since this may result in having to reposition the corner holders 23 and safety bumpers 27 correctly back onto the device stand 1 in the proper position the next time the mobile device 2 is to be attached.

It may therefore be desirable to have a means for disengaging the mobile device 2 from the corner holders 23 or bumpers 27 without having to remove the corner holders 23 and bumpers 27 from the device stand 1. This way, the corner holders 23 and bumpers 27 may be left in the proper position on the device stand 1 for the time the mobile device 2 is to be attached.

In one embodiment of this type, bumper 27 may be attached to the corner holder 23, and the corner holder 23 and bumper 27 may be made of material that is flexible so that the corner portion of the corner holder 23 and bumper 27 may be bent backwards, thus allowing the safety bumper 27 that may be attached to the corner portion of the corner holder 23 and acting as a gripping element to move backwards in order to expose the corner or side of the mobile device 2. This is depicted in FIG. 9D.

When the corner or side of the mobile device 2 is exposed, it may allow the corner or side of the mobile device 2 to be removed from the corner holder 23.

The material of the corner holder 23 and bumper 27 may be chosen to be flexible enough to allow adequate flexing in order to allow the bumper 27 to move back far enough to expose the corner or side of the mobile device 2 for removal, and also stiff enough to adequately support and hold the safety bumper 27 such that it may adequately grip, support and protect the corner of the mobile device 2 while in its forward default position covering the corner of the mobile device 2. It may also be preferable that the material of the corner holder 23 be somewhat soft in order to provide a non-abrasive and shock absorbing base for the mobile device 2.

It may also be desirable that material of the corner holder 23 and bumper 27 to be stiff enough such that in its un-flexed state, it may hold the safety bumper 27 in its forward position to adequately grip and protect the corner of the mobile device 2.

It may be necessary for the corner holder 23 to be comprised of layers of different materials to achieve the preferred characteristics as described above, or the characteristics may be achieved with a single material.

Once several of the corners or sides of the mobile device 2 are exposed by bending the safety bumpers 27 backwards, the mobile device 2 may be disengaged and removed from the corner holders 23 and bumpers 27 and from the device stand 1.

While the description above describes the bumper 27 being attached to the corner portion of the corner holder 23, the bumper 27 may instead be attached to any other portion of the corner holder 23.

In another embodiment, the corner bumper 27 may not be attached or integrated into the corner holder 27 and may instead be attached directly to or be a part of the device stand 1 as depicted in FIG. 8B. In this case, the bumpers 27a may be incorporated into the device stand 1 itself, may be attached to the device stand 1 using Velcro, snaps, jacks or other means, or may be an extension of the body or another portion of the device stand 1. In addition, the bumpers 27a may be positioned in various places on the device stand 1 to result in protection of the mobile device 1.

If the bumpers 27a are formed as part of the device stand 1, the bumpers 27a of the device stand1 may be comprised of corners, sides or edges of the device stand 1 that may protrude outward and may extend beyond the face of the mobile device 2 that may be attached to the device stand 1. In this regard, the corners, sides or edges that may extend beyond the face of the mobile device 2 may prevent the mobile device from hitting the ground and may protect the mobile device from damage that may result from falling onto a hard surface similarly to the other embodiments of the safety bumpers described above.

While FIG. 8B depicts the bumpers 27a as extending downward form the sides of the device stand 1, the bumpers may extend from other positions on the device stand 1.

Also, the bumpers 27a may or may not be used as gripping members and may or may not hold the mobile device in place on the device stand 1. FIG. 8B depicts the bumpers 27a as not gripping the mobile device 2, but instead, they may include grooves (not shown) that may be utilized to hold the mobile device 2 (not shown).

If the bumpers 27a are to be used as gripping members to hold the mobile device 2 in place on the device stand 1, the bumpers 27a or the means by which the bumpers 27a may be attached to the device stand 1 may be flexible such that the corner of the mobile device 2 being held by the bumper 27a may be exposed and subsequently disengaged and removed from the device stand 1 by flexing the bumper 27a or the attachment means of the bumper 27 backward with respect to the device stand 1. This may expose the corner or side of the mobile device 2 such that it may be removed from the device stand 1. This is similar to the earlier embodiment described in relation to FIG. 9D but in this case the bumpers 27a are attached to or a part of the device stand 1 and not the corner holders 23.

In another embodiment where the safety bumper 27 may be acting as a gripping element to secure the mobile device 2 to the device stand 1, the bumper 27 may be folded back to expose the corner of the mobile device 2 for removal.

In this case and as shown in FIG. 9E, the bumper 27 may be attached to the corner holder 23 by a hinge or other mechanism 28a that may allow the bumper 27 to fold backwards in order to expose the corner of the mobile device 2 for removal. This folding mechanism 28a may also include a locking clip that may hold the bumper 27 down in a locked default position covering and gripping the corner of the mobile device 2, that may also be released in order to allow the bumper 27 to fold backwards in order to expose the corner of the mobile device 2.

While this description describes the bumper 27 as being attached to the corner holder 23, it may not be attached to the corner holder 23 and may instead be attached to the device stand 1. In this case, the bumper 27 may be attached to the device stand 1 using a similar means that allow the bumper 27 to fold backwards in order to expose and release the corner of the mobile device 2.

While these descriptions describe the bumper 27 as folding backwards, the bumper may also fold in other directions such as sideways, forward, or other directions.

In another embodiment where the safety bumper 27 may be acting as a gripping element to secure the mobile device 2 to the device stand 1, the bumper 27 may be rotated to expose the corner of the mobile device 2 for removal.

In this case and as shown in FIGS. 9E and 9F, the bumper 27 may be attached to the corner holder 23 by a rod or other mechanism 28b that may allow the bumper 27 to rotate around in order to expose the corner of the mobile device 2 for removal. This mechanism may also include one or more detents 28c that may hold the bumper 27 forward in a locked default position covering and gripping the corner of the mobile device 2 that may also be released in order to allow the bumper 27 to rotate around in order to expose the corner of the mobile device 2.

A side view of this embodiment is depicted in FIG. 9E.

A top view of this embodiment is depicted in FIG. 9F.

While this description describes the bumper 27 as being attached to the corner holder 23, it may not be attached to the corner holder 23 and may instead be attached to the device stand 1. In this case, the bumper 27 may be attached to the device stand 1 using a similar means that allow the bumper 27 to rotate in order to expose and release the corner of the mobile device 2.

While these descriptions describe the bumper 27 as rotating around horizontally with respect to mobile device 2, the bumper 27 may also rotate in other directions such as upwards, sideways, forward, or other directions.

In addition, while the embodiments described above in relation to bending, folding, rotating or otherwise moving a safety bumper 27 that may secure the mobile device 2 to the device stand 1 in order to expose the corner of the mobile device 2, it should be noted that if the bumper 27 were instead securing a side of the mobile device 2 instead of a corner, that the same technique may be used to expose the side of the mobile device 2 such that the mobile device 2 may be disengaged and removed from the device stand 1.

It should also be noted that while the above descriptions mainly describe the bumper 27 as being bent back, folded, rotated or otherwise moved in order to expose a corner, a side or another component of the mobile device 2 which it may be securing to the device stand 1, other elements of the gripping member or corner holder 23 may instead be bent back, folded, rotated or otherwise moved in order to result in the exposure of the gripped component of the mobile device 2 and subsequent disengagement of the mobile device 2 from the device stand 1.

Also, the above described sequence of steps that may be taken to disengage and remove a mobile device 2 from the device stand 1 may be performed in reverse to insert, engage and secure the mobile device 2 to the device stand. For example, while the above descriptions describe bending back, folding, rotating or otherwise moving the corner holder 23, safety bumpers 27 or other gripping member to disengage the mobile device 2 from the device stand 1, the same functionality may be used in reverse to insert the mobile device into the corner holder 23, the safety bumpers 27 or other gripping members. That is, with the corner holders 23, safety bumpers 27 or other gripping members attached to and properly positioned on the face of the device stand 1 to receive and accommodate a mobile device 2, the corner holders 23, safety bumpers 27 or other gripping members may be bent back, folded, rotated or otherwise moved in order to allow a corner or side of the mobile device 2 to be inserted into the corner holders 23, safety bumpers 27 or other gripping members. With a corner or side of the mobile device 2 inserted into the corner holders 23, bumpers 27 or other gripping members, the corner holders 23, bumpers 27 or other gripping members may be returned to a position or configuration that may overlap or otherwise grip the corners or sides of the mobile device 2 in order to secure the mobile device 2 to the device stand.

It should be noted that different types of mobile devices, for example smartphone and tablet computers, may have touch screens that may have workable surface areas that extend closer to the side and corner edges of the mobile devices when compared to each other. For example, the workable area of a smartphone touchscreen may extend closer to the edges of the smartphone compared to how close the workable area of a tablet computer extends to its edges. Therefore, a bumper that may be designed to secure a tablet computer to the device stand 1 and not cover up any workable area of the tablet computer touchscreen may cover up some of the workable touchscreen area if used to secure a smartphone.

It may be preferable therefore to have an adapter plug 27b as shown in FIG. 9J that may fit into the front of the bumper 27 to generally decrease the distance that the front of the bumper may overlap the top of the mobile device 2 when the mobile device 2 is being secured to the device stand 1 using bumpers 27.

For instance, when the bumper 27 is being used to grip a corner of a mobile device 2 utilizing the V-notch 27c of the bumper 27, it may be necessary to move the V-notch 27c closer to the front lip of the bumper 27 in order to decrease the overlap of the bumper 27 on the mobile device 2. As shown in FIG. 9K, this may be accomplished by having a V-notch 27d in the adapter plug 27b such that when the adapter plug 27b is inserted into the bumper 27, it may generally fit into the V-notch 27c of the bumper 27 and essentially replace the V-notch 27c of the bumper 27 with its own V-notch 27d that is closer to the front lip of the bumper 27. This may decrease the overlap of the bumper 27 over the corner of the mobile device 2. It may be preferable for the adapter plug 27b to have dimensions such that the resulting overlap dimension once the adapter plug 27b is inserted into the bumper 27 results in an overlap that does not interfere with the usable touchscreen area of the mobile device 2 with which it is to be used. It should also be noted that the adapter plug 27b may not need to fit into the V-notch 27c of the bumper 27 but it may be preferable that the adapter plug 27b fit snugly into the front area of the bumper 27 in order to be secure.

For example, comparing FIG. 9BB with FIG. 9K, it can be seen that the overlap dimension C of a mobile device 2 inserted into a bumper 27 without an adapter plug 27b in FIG. 9BB is greater than the overlap dimension D of a mobile device 2 inserted into a bumper 27 with an adapter plug 27b inserted into the bumper 27 in FIG. 9K. In this case, the insertion of the adapter plug 27b into the bumper 27 has essentially resulted in a decreased bumper overlap on the mobile device 2 as depicted.

In addition, when the bumper 27 is being used to grip a side of a mobile device 2 utilizing the front corners of the V-notch 27c of the bumper 27, it may be necessary to move the front corners of the V-notch 27c closer to the front lip of the bumper 27 in order to decrease the overlap of the bumper 27 on the mobile device 2. As shown in FIG. 9N, this may be accomplished by having a V-notch 27d with front edges and sides 27e on the adapter plug 27b such that when the adapter plug 27b is inserted into the bumper 27, it may generally fit into the V-notch 27c of the bumper 27 and essentially replace the front edges of V-notch 27c of the bumper 27 with its own front edges and sides 27e of V-notch 27d that are closer to the front lip of the bumper 27. This may decrease the overlap of the bumper 27 over the side of the mobile device 2. It may be preferable for the adapter plug 27b to have dimensions such that the resulting overlap dimension once the adapter plug 27b is inserted into the bumper 27 results in an overlap that does not interfere with the usable touchscreen area of the mobile device 2. It should also be noted that the adapter plug 27b may not need to fit into the V-notch 27c of the bumper 27 but it may be preferable that the adapter plug 27b fit snugly into the front area of the bumper 27 in order to be secure.

For example, comparing FIG. 9CC with FIG. 9N, it can be seen that the overlap dimension A of a mobile device 2 inserted into a bumper 27 without an adapter plug 27b in FIG. 9CC is greater than the overlap dimension B of a mobile device 2 inserted into a bumper 27 with an adapter plug 27b inserted into the bumper 27 in FIG. 9N. In this case, the insertion of the adapter plug 27b into the bumper 27 has essentially resulted in a decreased bumper overlap on the mobile device 2 as depicted.

Additionally, FIG. 9M depicts a side view of a bumper 27 with a front lip overlap of dimension A and without an adapter plug 27b inserted into the bumper 27, while FIG. 9L depicts the side view of a bumper 27 with a front lip overlap dimension B with an adapter plug 27b inserted into the bumper 27. It can be seen when comparing overlap dimension A of FIG. 9M to overlap dimension B of FIG. 9L that overlap dimension B is less than overlap dimension A.

In another embodiment, the device stand1 may fold up into a briefcase-type apparatus for transporting and protecting the attached mobile device, and then fold out into a configuration similar to the embodiments described above.

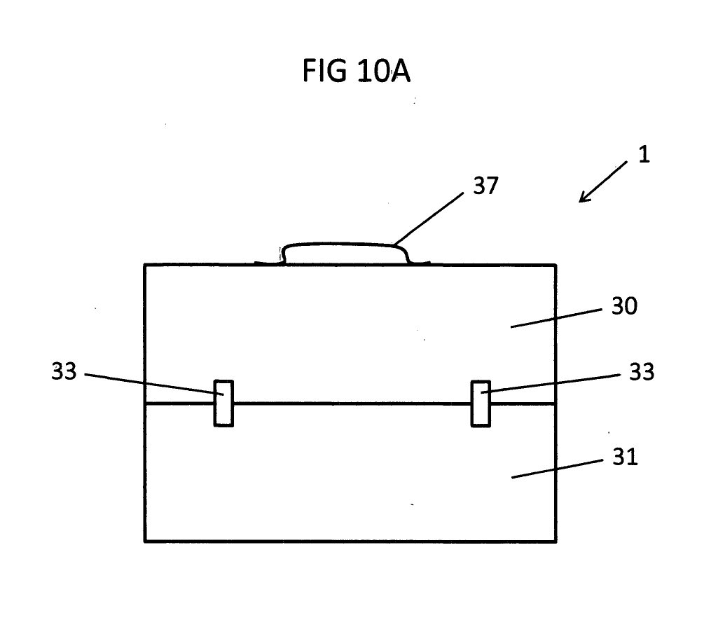

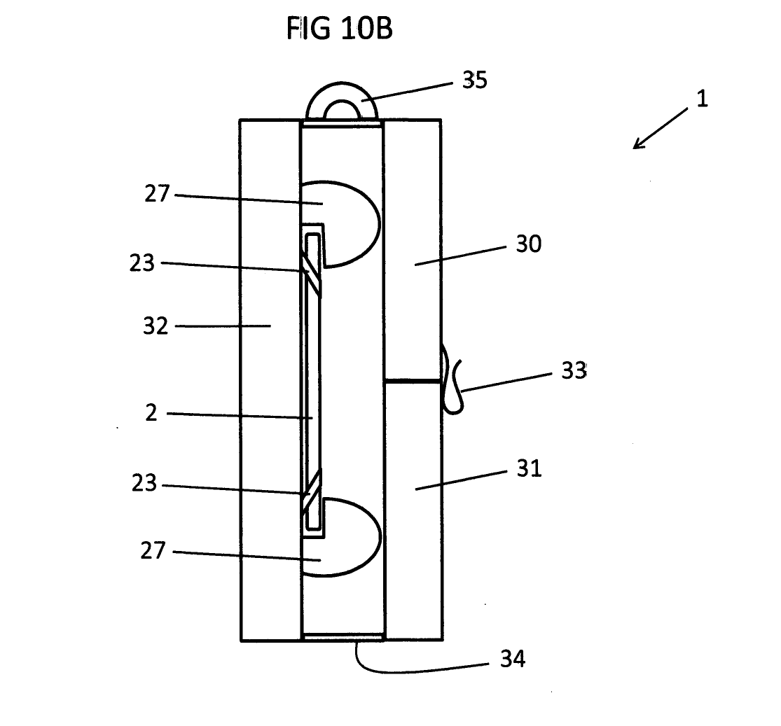

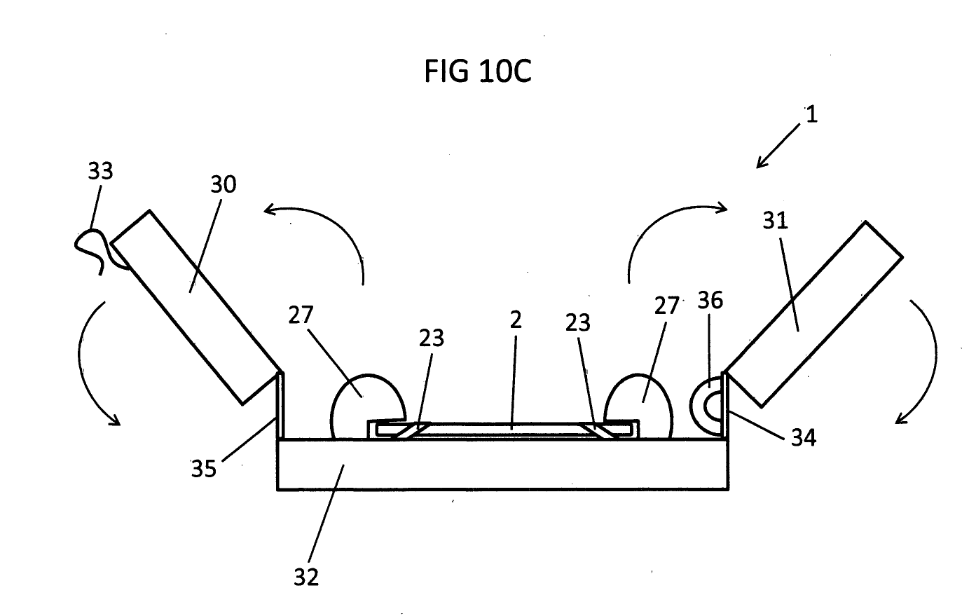

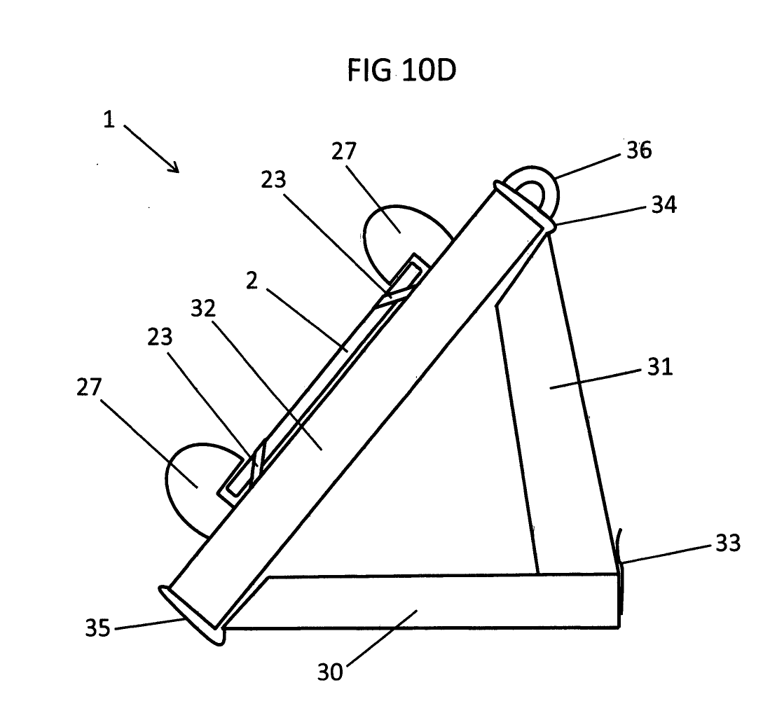

FIG. 10A depicts the front view of the device stand1 in its folded-up configuration, and FIG. 10B depicts the side view of the device stand1 in its folded-up configuration.

As shown in FIG. 10A and FIG. 10B, the device stand1 may comprise of an upper front section 30, a lower front section 31, a back section 32, at least one latch 33 that may be used to hold the upper front section 30 and lower front section 31 together while folded up, an upper bridge section 35 connecting the top of the upper front section 30 to the top of the back section 32, and a lower bridge section 34 connecting the bottom of the lower front section 31 to the bottom of the back section 32. The device stand1 may also include the safety bumpers 27, the corner holders 23 and the Velcro sheet 22 (not shown) described in the prior embodiments within this specification.

In FIG. 10B, the mobile device 2 may be attached to the inner face of the back section 32 utilizing corner holders 23, or safety bumpers 27 as grippers, and the Velcro sheet 22 as described in prior embodiments within this specification, or by other means.

In the folded-up configuration depicted in FIG. 10A and FIG. 10B, the device stand1 may provide an easy way to carry and transport the mobile device 2 attached within.

In addition, in the folded-up configuration depicted in FIG. 10A and FIG. 10B, the device stand1 may provide protection to the mobile device 2 held within the device stand1, and may protect it from direct blows to the device stand1 and from impact to the device stand1 resulting from being dropped onto hard surfaces.

FIG. 10C shows the foldable device stand 29 being opened up to be converted into a similar shape and configuration as the embodiments described in prior sections of this specification. The latch 33 may be opened and the upper front section 30 and the lower front section 31 may be folded outwards as shown.

FIG. 10D shows the device stand 1 in its fully opened and locked position. Upper front section 30 and lower front section 31 may be rotated and positioned on the back side of the back section 32 and may be connected to each other using the latch 33 or other means. This may form a generally wedge shaped device stand 1. The exposed surface of the back section 32 may include a Velcro sheet 22 as described in earlier embodiments, and the mobile device 2 may be attached to the exposed surface of the back section 32 using corner holders 23 with straps 25, by bumpers 27 acting as grippers or by other means. The safety bumpers 27 may also be in place and may be exposed to provide protection to the mobile device 2 from falling as described in the embodiments above.

As shown in FIG. 10A, a handle may be configured on the top area of the foldable device stand 29 for carrying the unit.

As well, as shown in FIG. 10C and FIG. 10D, a second handle 36 may be configured in the inner area of the upper bridge 34 so that it may be exposed when the device stand1 is opened up and may be utilized to carry the unit when it is locked open.

While FIG. 10A, FIG. 10B, FIG. 10C and FIG. 10D show the device stand1 as being a generally rectangular shape when in its folded configuration, the device stand1 may also be other shapes such as circles, ovals, trapezoids, triangles and other shapes while in its folded-up position.

While FIG. 10A, FIG. 10B, FIG. 10C and FIG. 10D show the device stand1 as being a generally wedge shaped stand when in its open and locked position, the device stand1 may be other shapes such as a pyramid, a hybrid of a wedge and a pyramid, or other shapes while in its unfolded and locked position.

The materials used to make the upper front section 30, the lower front section 31 and the back section 32 of the device stand may include foam, rubber, plastic, compressed board, leather, stuffed pillow material, or any other material that will provide the necessary stability and functionality. The device stand1 may or may not be covered in a fabric to increase its softness.

The device stand1 may or may not include pockets that may be used to hold screen cleaners and chargers for the mobile device or other items such as smart phones.

In yet another embodiment, any of the embodiments described above may include external speakers that may be integrated into the body of the device stand 1, and that may be connected (using wires, a wireless connection or other means) to the mobile device 2 and that may increase the volume and/or fidelity of any audio content emanating from the mobile device 2.

The speakers may be integrated into the body of the device stand 1 in such a way that they may not be removed from the body of the device stand 1, or they may be integrated with the body of the device stand 1 in such a way that they may be removed from the body of the device stand 1 and repositioned and used as desired.

The device stand 1 may also utilize other means to increase the volume of the audio that may be emanating from the mobile device. These means may include audio funnels, physical audio channels or other means that may redirect the audio waves that may emanate from the speakers of the mobile device 2 into a new direction that is more easily heard by the user.

In some cases, mobile devices may have speakers that are positioned on the back of the mobile device. These speakers may therefore be covered up when the mobile device is placed into the device stand. It may therefore be desirable to have a means that may redirect the sound emanating from the rear speakers forward towards the user in order to increase the volume and fidelity of the sound.

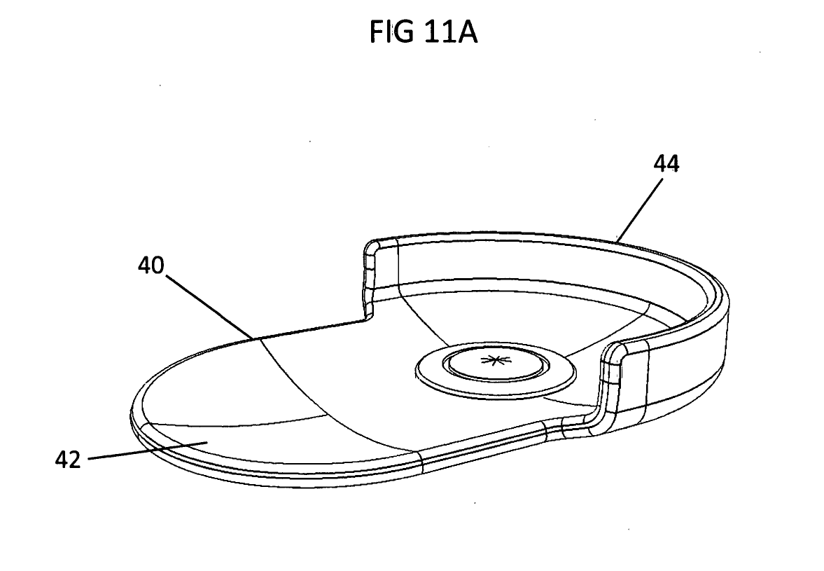

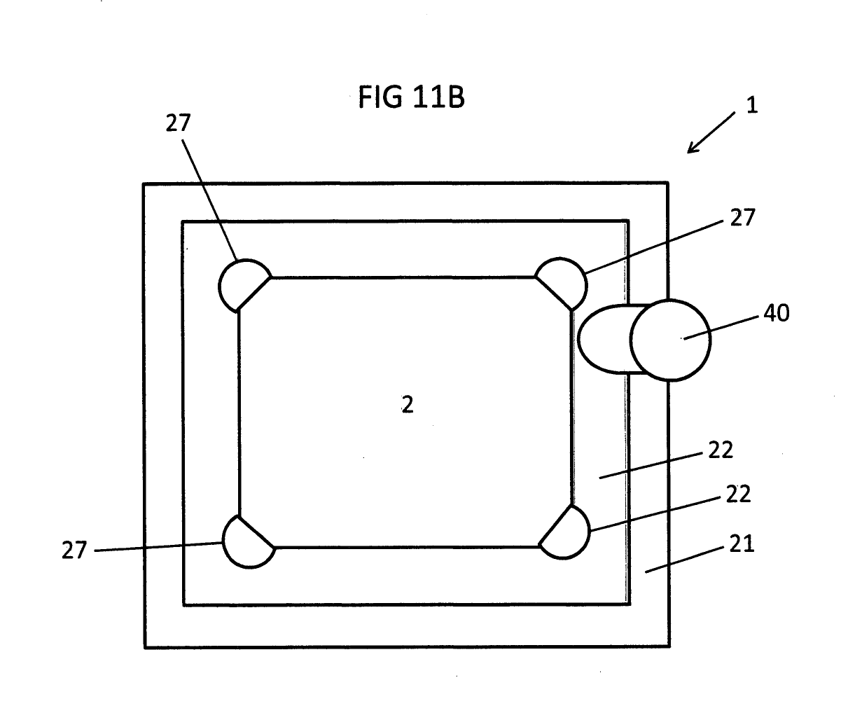

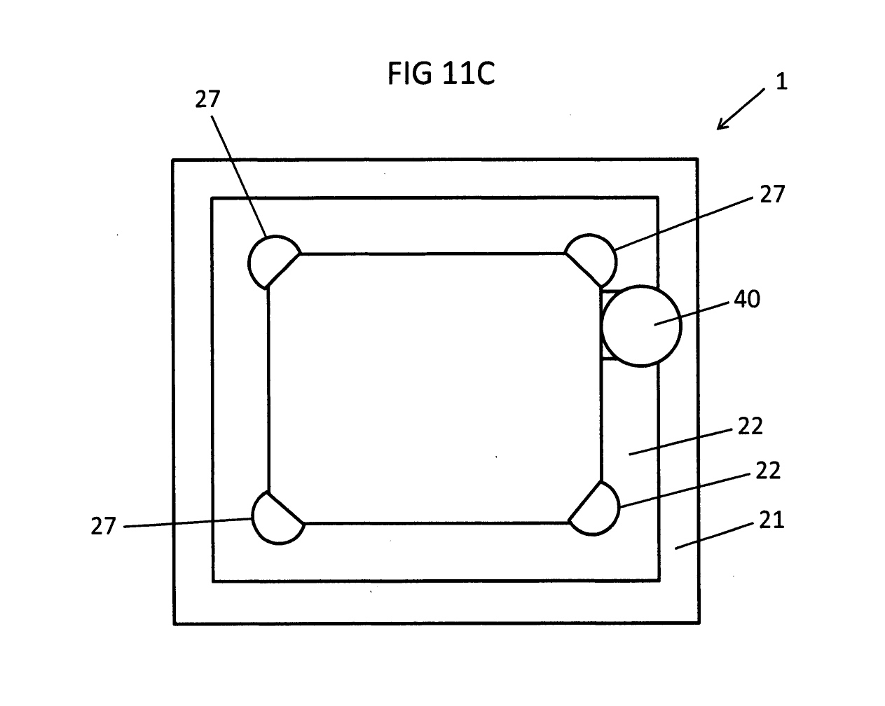

In one embodiment of this sort as shown in FIG. 11A, a speaker horn section 40 may comprise of a curved hollow bottom section 42, and a horn section 44. As shown in FIGS. 11B and 11C curved hollow bottom section 42 of speaker horn 40 may be inserted between the back surface of the mobile device 2 and the front face 21 of the device stand 1 in the region of the back side speaker (not shown) that may be on the mobile device 2. In this position, bottom section 42 of the speaker horn may generally cover the backside speaker on the mobile device 2 and redirect the audio outward toward the horn section 44. Horn section 40 may extend away from the body of the mobile device 2 and may redirect the audio emanating from the rear speaker and the curved hollow bottom section 42 forward towards the user. This may increase the volume and the fidelity of the audio emanating from the backside speaker thus improving the listening experience of the user.

The present invention includes a number of aspects and features which may be practiced alone or in various combinations or sub-combinations, as desired. While preferred embodiments of the present invention have been disclosed and described herein for purposes of illustration and not for purposes of limitation, it will be understood by those skilled in the art that various changes in form and detail may be made therein without departing from the spirit and scope of the invention.

What is claimed is:

1. A device for supporting equipment, comprising:
a stand with a face; and
a gripping member; and
a bumper.

2. The device of claim 1, wherein the bumper is incorporated into the gripping member.

3. The device of claim 1, wherein the front face includes a sheet of Velcro.

4. The device of claim 1, wherein one surface of the gripping member includes Velcro.

5. The device of claim 1, wherein one surface of the bumper includes Velcro.

6. The device of claim 1, wherein the gripping member and the bumper are attached to the face of the stand in order to secure a mobile device to the stand.

7. A device for supporting mobile devices, comprising:
a stand with a face; and
a sheet of Velcro on the front face for the attachment of components; and
a gripping member with a bumper and with one surface that includes Velcro;
wherein the gripping member is attached to the face of the stand in order to secure a mobile device to the stand.
